(19) United States
(12) Patent Application Publication
(10) Pub. No.: US 2025/0357987 A1
(43) Pub. Date: Nov. 20, 2025

(54) CHANNEL STATE INFORMATION REPORTING AND PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventors: Lu JIANG, Dongguan (CN); Xiaohang CHEN, Dongguan (CN); Gen LI, Dongguan (CN); Xueming PAN, Dongguan (CN)

(21) Appl. No.: 19/288,167

(22) Filed: Aug. 1, 2025

Related U.S. Application Data
(63) Continuation of application No. PCT/CN2024/074146, filed on Jan. 26, 2024.

(30) Foreign Application Priority Data
Feb. 2, 2023 (CN) 202310080562.0

(51) Int. Cl. H04B 7/06; H04W 74/0833

(52) U.S. Cl. CPC H04B 7/0626; H04W 74/0833

(57) ABSTRACT

A channel state information reporting and processing method and apparatus are disclosed. The method includes: receiving, by a terminal, indication information sent by a network side device, the indication information indicating a change related to channel state information (CSI) reporting configuration; and performing, by the terminal, CSI reporting based on the indication information.

### CROSS-REFERENCE TO RELATED APPLICATIONS

This application is a continuation application of International Application No. PCT/CN/2024/074146, filed on Jan. 26, 2024, which claims priority to Chinese Patent Application No. 202310080562.0, filed on Feb. 2, 2023 in China, which is incorporated herein by reference in their entirety.

### TECHNICAL FIELD

This application relates to the field of communication technologies and, in particular, to a channel state information reporting and processing method and apparatus, a terminal, and a network side device.

### BACKGROUND

In current communication systems, during periods of low network load or when only a small number of users are active, such as when the network disables certain antenna units (TxRUs) to conserve energy, the associated Channel State Information (CSI) configuration (e.g., measurement resource configuration or reporting configuration) may not be updated accordingly.

Consequently, the terminal may continue to perform measurements and reporting based on outdated configuration. This can lead to unnecessary measurements and the reporting of inaccurate CSI, which in turn hinders efficient scheduling by the network.

### BRIEF SUMMARY

Embodiments of this application provide a channel state information reporting and processing method and apparatus, a terminal, and a network side device, to solve the problem that the terminal performs invalid CSI measurement, and reported CSI is inaccurate.

According to a first aspect, a channel state information reporting and processing method is provided, including:
receiving, by a terminal, indication information sent by a network side device, where the indication information indicates a change related to channel state information (CSI) reporting configuration; and
performing, by the terminal, CSI reporting based on the indication information.

According to a second aspect, a channel state information reporting and processing apparatus is provided, including:
a receiving module, configured to receive indication information sent by a network side device, where the indication information indicates a change related to channel state information (CSI) reporting configuration; and
a CSI reporting module, configured to perform CSI reporting based on the indication information.

According to a third aspect, a channel state information reporting and processing method is provided, applied to a network side device and including:
sending, by a network side device, indication information to a terminal, where the indication information indicates a change related to channel state information (CSI) reporting configuration.

According to a fourth aspect, a channel state information reporting and processing apparatus is provided, including:
a sending module, configured to send indication information to a terminal, where the indication information indicates a change related to channel state information (CSI) reporting configuration.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface, where the communication interface is configured to: receive indication information sent by a network side device, where the indication information indicates a change related to channel state information (CSI) reporting configuration; and perform CSI reporting based on the indication information.

According to a seventh aspect, a network side device is provided. The network side device includes a processor and a memory, the memory stores a program or an instruction that can be run on the processor, and the program or the instruction is executed by the processor to implement the steps of the method according to the third aspect.

According to an eighth aspect, a network side device is provided, including a processor and a communication interface, where the communication interface is configured to send indication information to a terminal, and the indication information indicates a change related to channel state information (CSI) reporting configuration.

According to a ninth aspect, a channel state information reporting and processing system is provided, including a terminal and a network side device. The terminal may be configured to perform the steps of the channel state information reporting and processing method according to the first aspect, and the network side device may be configured to perform the steps of the channel state information reporting and processing method according to the third aspect.

According to a tenth aspect, a readable storage medium is provided. The readable storage medium stores a program or an instruction, and the program or the instruction is executed by a processor to implement the steps of the method according to the first aspect or the steps of the method according to the third aspect.

According to an eleventh aspect, a chip is provided. The chip includes a processor and a communication interface, the communication interface is coupled to the processor, and the processor is configured to run a program or an instruction to implement the method according to the first aspect or the method according to the third aspect.

According to a twelfth aspect, a computer program/program product is provided, where the computer program/program product is stored in a storage medium, and the computer program/program product is executed by at least one processor to implement the steps of the method according to the first aspect or the steps of the method according to the third aspect.

In the embodiments of this application, the terminal can learn of, by receiving the indication information sent by the network side device, the change related to the CSI reporting configuration, to perform CSI reporting based on the indication information, and avoid the problem that the terminal performs invalid CSI measurement, and reported CSI is inaccurate due to the fact that CSI reporting cannot meet a scenario requirement.

### BRIEF DESCRIPTION OF DRAWINGS

FIG. 1 is a block diagram of a wireless communication system;

FIG. 2 is a first schematic flowchart of a channel state information reporting and processing method according to an embodiment of this application;

FIG. 3 is a first schematic diagram of an application according to an embodiment of this application;

FIG. 4 is a second schematic diagram of an application according to an embodiment of this application;

FIG. 5 is a third schematic diagram of an application according to an embodiment of this application;

FIG. 6 is a fourth schematic diagram of an application according to an embodiment of this application;

FIG. 7 is a fifth schematic diagram of an application according to an embodiment of this application;

FIG. 8 is a second schematic flowchart of a channel state information reporting and processing method according to an embodiment of this application;

FIG. 9 is a schematic diagram of a structure of an apparatus module of FIG. 2;

FIG. 10 is a schematic diagram of a structure of an apparatus module corresponding to FIG. 8;

FIG. 11 is a schematic diagram of a structure of a communication device according to an embodiment of this application;

FIG. 12 is a schematic diagram of a structure of a terminal according to an embodiment of this application; and

FIG. 13 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Understandably, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. In addition, objects distinguished by “first” and “second” are generally of a same type, and the number of objects is not limited, for example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A new radio (New Radio, NR) system is described in the following description for illustrative purposes, and the NR terminology is used in most of the following description, although these technologies can also be applied to applications other than the NR system application, such as the 6th Generation (6G) communication system.

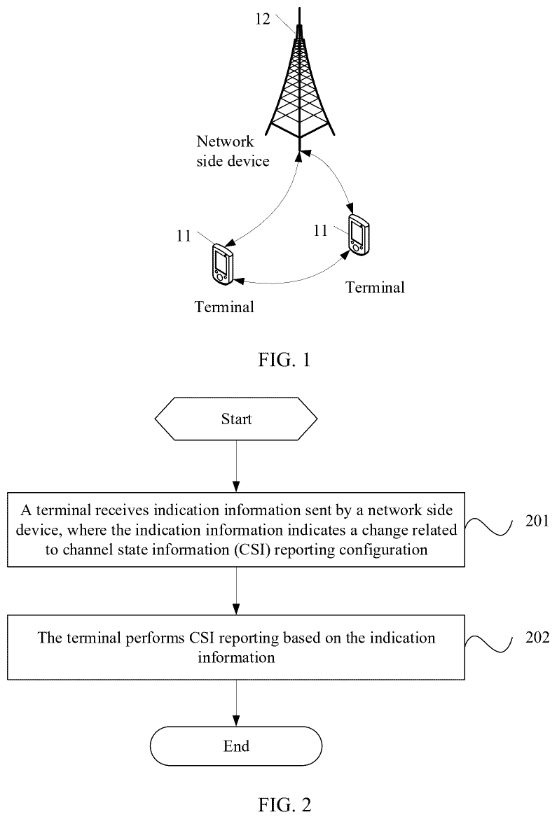

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer, (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart bangle, a smart anklet, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a mobile hotspot (Wi-Fi) node, or the like. The base station may be referred to as a NodeB, an evolved NodeB (eNB), an access point, a Base Transceiver Station (BTS), a radio base station, a radio transceiver, a Basic Service Set in (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in the embodiments of this application, only a base station in an NR system is used as an example, and a specific type of the base station is not limited.

For ease of understanding, some content involved in the embodiments of this application is described below.

A conventional network side device (such as a base station) mainly uses methods such as on-site power-off, time-control switch, cell block, or the like to save energy, but these methods are extensive and cannot take into account user perception. In the era of 5G, due to the fact that a 5G base station adopts 64T64R large-scale array antennas and supports greater bandwidth and other factors, energy consumption of the 5G base station is higher than that of a 4G base station. Secondly, a 5G frequency band is high, and a coverage area of a single station is small. To achieve a coverage effect of a 4G network, a deployment scale of the 5G base station may be 2 to 3 times that of the 4G base station. However, more power consumption of device and more stations indicate more power consumption. The high power consumption of 5G has become the pain point of network operation at present, so it is imperative to study the energy saving of 5G base station technology.

According to a realization principle, base station energy saving may be divided into symbol level shutdown, carrier level shutdown, channel level shutdown, and deep sleep technology. In spatial energy-saving technology, massive multiple in multiple out (Multiple In Multiple Out, MIMO) consumes a lot of energy due to a large number of antennas and corresponding radio frequency devices. When there is a small number of terminals, also referred to as User Equipment (UE), in a cell, a capacity/coverage gain brought by mMIMO may be redundant. In this case, the network side device may dynamically deactivate some TxRUs to serve few remaining users, thereby achieving the purpose of network energy saving. After some TxRUs are deactivated, a coverage area of a beam may be reduced, and a beam width may be increased.

With reference to the accompanying drawings, the following describes in detail a channel state information reporting and processing method and apparatus, a terminal, and a network side device provided in the embodiments of this application by using some embodiments and application scenarios thereof.

As shown in FIG. 2, the channel state information reporting and processing method according to this embodiment of this application includes the following steps.

Step 201: A terminal receives indication information sent by a network side device, where the indication information indicates a change related to channel state information (CSI) reporting configuration.

Step 202: The terminal performs CSI reporting based on the indication information.

In this way, based on step 201 and step 202, the terminal can learn of, by receiving the indication information sent by the network side device, the change related to the CSI reporting configuration, to perform CSI reporting based on the indication information, and avoid the problem that the terminal performs invalid CSI measurement, and reported CSI is inaccurate due to the fact that CSI reporting cannot adapt a scenario requirement.

It should be noted that, in the method of this embodiment of this application, in a case that a port configuration changes after the network side device enters an energy-saving state, the network side device can send the indication information to indicate the change related to CSI reporting configuration, so that the terminal performs corresponding CSI reporting based on the change, and supports the port configuration change after the network side device enters the energy-saving state.

Optionally, the indication information is transmitted through at least one of the following signaling:
group common Downlink Control Information (DCI);
broadcast DCI;
multicast DCI; and
a Media Access Control Control Element (MAC CE).

Optionally, the group common DCI may be an extension of an existing DCI format (format), such as an extension of DCI format 2_0 or an extension of paging DCI.

Alternatively, optionally, the group common DCI may be a new group common DCI format scrambled by a group common radio network temporary identity (Radio Network Temporary Identity, RNTI). In this case, the group common DCI is DCI dedicated to carrying the indication information.

Similarly, the broadcast DCI, the multicast DCI, and the MAC CE may alternatively be extensions of the existing format or new signaling dedicated to carrying the indication information.

Optionally, in this embodiment, the indication information includes at least one of the following:
a serving cell identity;
a Band Width Part (BWP) identity;
first indication information, where the first indication information indicates to activate or deactivate a first object;
CSI-RS related information;
power offset related information;
second indication information, where the second indication information is in a mapping relationship with the first object;
Random Access Channel (RACH) related information;
an antenna port muting pattern identity;
port related information; and
third indication information, where the third indication information indicates at least one CSI reporting configuration, where
the first object includes at least one of the following:
a serving cell; a BWP; a CSI reporting configuration; a CSI-RS resource set; a CSI-RS resource configuration; a CSI-RS resource; and a CSI-RS resource group.

The first object may alternatively include power offset related information, RACH related information, an antenna port muting pattern, and port related information. For one or more items included in the first object, each item can be one or more. For example, the first object includes the CSI reporting configuration (CSI-ReportConfig), and CSI-ReportConfig may be CSI-ReportConfig1 and CSI-ReportConfig2.

The first indication information may be 1 bit (bit), for example, “0” for deactivation and “1” for activation. The first object to be activated or deactivated may be default (pre-configured), including CSI-ReportConfig, CSI-ResourceConfig, NZP-CSI-RS-ResourceSet, and NZP-CSI-RS-Resource. The mapping relationship between the second indication information and the first object may also be default (pre-configured).

In addition, other information included in the indication information other than the first indication information may be activated or deactivated by default. For example, in a case of activation by default, a BWP identity (Id) carried by the indication information is an activated BWP Id; and in a case of deactivation by default, a BWP Id carried by the indication information is a deactivated BWP Id. A number of bits of the BWP Id carried by the indication information may be determined based on a number of configured BWPs. Activation or deactivation by default may be specified in advance by a protocol.

It should be noted that “the indication information includes at least one of the following” can be understood as “the indication information has at least one of the following functions” or “the indication information has at least one of the following configurable fields (configurable field)”.

Optionally, the power offset related information includes: at least one power offset value; or an identity corresponding to at least one power offset value, where the power offset value is a power offset value between a physical downlink shared channel (PDSCH) and a CSI-RS. Protocol description includes a powerControlOffset field, which represents a relative value of PDSCH RE power offset relative to NZP CSI-RS RE, on a per-dB basis.

Herein, when there is no corresponding first indication information, the power offset related information may be considered as “activated” or “deactivated” power offset related information by default.

Optionally, the RACH related information includes at least one of the following: a random access channel occasion (RACH Occasion, RO) configuration; and a mapping relationship between a synchronization signal block (SSB) and an RO.

Herein, the RO configuration may be a Physical Random Access Channel (PRACH) Configuration Index. The mapping relationship between an SSB and an RO may be a number of SSBs per RO and a number of preambles per SSB (ssb-perRACH-Occasion And CB-Preambles Per SSB), and may alternatively be ssb-perRACH-Occasion in a beam failure recovery configuration (BeamFailureRecoveryConfig).

When there is no corresponding first indication information, the RACH related information may be considered as “activated” or “deactivated” RACH related information by default.

Optionally, the antenna port muting pattern identity (Muting pattern Id) is a port pattern formed after an antenna port switch. For example, Radio Resource Control (RRC) configures Muting pattern Id, such as, an Id of mutingpattern1 is 0, an Id of mutingpattern2 is 1, and the like. The indication information indicates corresponding mutingpattern or mutingpatternId, that is, CSI reporting of corresponding mutingpattern is activated or deactivated. The antenna port muting pattern may also be described as a pattern/mode of the antenna port switch. An essence of various descriptions can be understood as that the port has different switch states at different moments, and these different switch states can be defined as different switch patterns.

When there is no corresponding first indication information, Muting pattern Id may be considered as “activated” or “deactivated” Muting pattern by default.

Optionally, the port related information includes at least one of the following: a port configuration identity, a number of ports, and a port switch pattern. Herein, the port related information includes the number of ports. If the number of ports is indicated to be 32, CSI reporting of 32 ports will be activated or deactivated; and if the number of ports is indicated to be 16, CSI reporting of 16 ports will be activated or deactivated. Port related information includes a port configuration Id, for example, port configuration 1 (32 ports) is Id 0, and port configuration 2 (16 ports) is Id 1. The indication information includes the port configuration Id, that is, indicates CSI reporting of a corresponding port configuration to be activated or deactivated.

When there is no corresponding first indication information, the port related information may be considered as “activated” or “deactivated” port related information by default.

Optionally, the mapping relationship between second indication information and a first object is pre-configured, for example, configured by RRC. RRC configures a mapping relationship between different indexes (Index) and a first object, and the second indication information is an index, indicating the activated or deactivated first object. For example, RRC configures a mapping relationship between each Index and BWP Id, and when the indication information includes the second indication information, CSI report config of a corresponding BWP Id is activated or deactivated by using the second indication information.

A mapping relationship between second indication information and a first object may be configured by one table (that is, each row in the table represents mapping between an index and a plurality of pieces of content), or may be configured by a plurality of tables, for example, IndexA is mapping between BWP Id and CSI report config, IndexB is mapping between CSI resource config and CSI resource set, and the like.

When there is no corresponding first indication information, the second indication information may be considered as “activated” or “deactivated” second indication information by default.

Optionally, based on energy-saving effect, the second indication information may be pre-configured with Index values in different energy-saving states and first objects corresponding to different Index values. In this case, the second indication information may also be referred to as energy-saving indication information (energy-saving indication Index). For example, energy-saving indication Index0 is configured with mapping between CSI report config1 and NZP-CSI-RS-Resourceset3 included in the report config, and energy-saving indication Index1 is configured with mapping between CSI report config2 and NZP-CSI-RS-Resourceset2 included in the report config. In this way, a corresponding resource set is activated/deactivated by indicating the corresponding energy-saving indication Index.

Optionally, the CSI-RS related information includes at least one of the following:
fourth indication information, where the fourth indication information indicates at least one CSI-RS resource set (NZP-CSI-RS-ResourceSet);
fifth indication information, where the fifth indication information indicates at least one CSI-RS resource configuration (CSI-ResourceConfig);
sixth indication information, where the sixth indication information indicates at least one CSI-RS resource (NZP-CSI-RS-Resource); and
seventh indication information, where the seventh indication information indicates at least one CSI-RS resource group (NZP-CSI-RS-Resource (group)), and the CSI-RS resource group is a subset of a CSI-RS resource set, or the CSI-RS resource group includes a plurality of CSI-RS resource sets.

Herein, any one of the fourth indication information to the seventh indication information, and the third indication information may realize first-level indication (direct indication); and two or more of the third indication information to the seventh indication information may realize multi-level indication. The multi-level indication refers to which CSI-RS resource set associated with which CSI report that needs to be activated is included in the indication information, or which group of CSI-RS Resources in which CSI-RS resource set associated with which CSI report that needs to be activated is included in the indication information, or which one or more powercontroloffsets of which group of CSI-RS Resources in which CSI-RS resource set associated with which CSI report that needs to be activated is included in the indication information.

Both the CSI-RS resource group and the CSI-RS resource set include one or more CSI-RS resources, but the CSI-RS resource group may be a subset of the CSI-RS resource set, that is, the CSI-RS resource set can be divided into one or more CSI-RS resource groups; or one or more CSI-RS resource sets may form one or more CSI-RS resource groups.

When there is no corresponding first indication information, “indication” of the third indication information to the seventh indication information may be considered as “indicate to activate” or “indicate to deactivate” by default.

Optionally, the third indication information includes at least one of the following:
a CSI reporting configuration identity;
CSI reporting configuration list information;
entry information in a CSI reporting configuration list; and
a first bitmap, where the first bitmap includes bits corresponding to different CSI reporting configurations.

That is, the third indication information can be presented as a CSI reporting configuration identity (namely, CSI-ReportConfig Id, or CSI-RS reportConfig Id); CSI reporting configuration list (namely, CSI-ReportConfig. List, or CSI-RS report config. List) information; entry information in the CSI reporting configuration list, where in this case, each Entry in the CSI reporting configuration list may include one or more CSI reporting configurations; and a first bitmap.

An example in which the third indication information is formally presented as the first Bitmap is used. In the first Bitmap, 1 bit represents acting on a periodic configuration/semi-static configuration/aperiodic configuration, 4 bit represents which configurations among four CSI-RS reportConfig are activated/deactivated, 1000 represents activating a 1^{st} configuration and deactivating other three configurations, and 1100 represents activating 1^{st} and 2^{nd} configurations and deactivating 3^{rd} and 4^{th} configurations.

Optionally, the fourth indication information includes at least one of the following:
a CSI-RS resource set identity;
CSI-RS resource set list information;
entry information in a CSI-RS resource set list; and
a second bitmap, where the second bitmap includes bits corresponding to different CSI-RS resource sets.

That is, the fourth indication information can be presented as a CSI-RS resource set identity (CSI-RS resource set Id); CSI-RS resource set list (CSI-RS resource Set list) information; a second bitmap; and Entry information in the CSI-RS resource set list. In this case, each Entry in the CSI-RS resource set list may include one or more CSI-RS resource sets, for example, Entry1: Set1, set2, set3; Entry2: Set2, set3; Entry3: Set4, set5, and the resource set is activated by indicating one or more entries in the CSI-RS resource set list.

Optionally, the fifth indication information includes at least one of the following:
a CSI-RS resource configuration identity;
CSI-RS resource configuration list information;
entry information in a CSI-RS resource configuration list; and
a third bitmap, where the third bitmap includes bits corresponding to different CSI-RS resource configurations.

That is, the fifth indication information can be presented as a CSI-RS resource configuration identity (namely, CSI-RS resource Config Id, or CSI-ResourceConfig Id); CSI-RS resource configuration list (namely, CSI-RS resource Config. List, or CSI-ResourceConfigList) information; Entry information in the CSI-RS resource configuration list, where in this case, each Entry in the CSI-RS resource configuration list may include one or more CSI-RS resource configurations; and a third bitmap.

Optionally, the sixth indication information includes at least one of the following:
a CSI-RS resource identity;
CSI-RS resource list information;
entry information in a CSI-RS resource list; and
a fourth bitmap, where the fourth bitmap includes bits corresponding to different CSI-RS resources.

That is, the sixth indication information can be presented as a CSI-RS resource identity (CSI-RS resource Id); CSI-RS resource list information; Entry information in the CSI-RS resource list, where in this case, each Entry in the CSI-RS resource list may include one or more CSI-RS resources; and a fourth bitmap.

Optionally, the seventh indication information includes at least one of the following:
a CSI-RS resource group identity;
CSI-RS resource group list information;
entry information in a CSI-RS resource group list; and
a fifth bitmap, where the fifth bitmap includes bits corresponding to different CSI-RS resource groups.

That is, the seventh indication information can be presented as a CSI-RS resource group identity (CSI-RS resources (group) Id); CSI-RS resource group list (CSI-RS resources (group) list) information; Entry information in the CSI-RS resource group list, where in this case, each Entry in the CSI-RS resource group list may include one or more CSI-RS resource groups; and a fifth bitmap.

Optionally, a grouping rule of the CSI-RS resource group is configured by the network side device; or is related to a number or density of ports of a CSI-RS resource included in the CSI-RS resource group.

Optionally, an effective start time of the indication information is one of the following:
a next time unit of a time unit in which the indication information is received;
an available effective moment closest to a moment at which the indication information is received; and
a moment that is a first time interval from a moment at which the indication information is received, where
the available effective moment is a moment with a fixed position in each available effective time window.

Herein, the time unit may be a slot, a second, a frame, or a subframe. The fixed position of the available effective moment in the available effective time window may be configured by the network side device in advance, or is a predefined effective time period plus offset, which is related to a SubCarrier Spacing (SCS). The first time interval may be configured in advance by the network side device (for example, indicated by the indication information), or is predefined duration. For example, the first time interval is equal to X slot/subframe/frame, and X is an integer greater than or equal to 1 and is specified in advance by a protocol or indicated by the indication information.

Optionally, a period of the available effective time window is the same as that of the indication information, that is, there is an available effective position in each indication period of the indication information.

Optionally, before the receiving, by a terminal, indication information sent by a network side device, the method further includes:
receiving, by the terminal, monitoring configuration information sent by the network side device; and
the receiving, by a terminal, indication information sent by a network side device includes:
receiving, by the terminal, the indication information based on the monitoring configuration information.

The monitoring configuration information may be configured through RRC.

Optionally, the monitoring configuration information includes at least one of the following:
a group common radio network temporary identity (RNTI) of the indication information;
a payload size of the indication information;
a search space configuration of the indication information; and
a start bit of content to be viewed by the terminal in the indication information.

Herein, the content to be viewed by the terminal refers to indication information applied to the terminal in the indication information; the content to be viewed by the terminal may be one or more of the following: a serving cell identity, a BWP identity, first indication information, CSI-RS related information, third indication information, power offset related information, second indication information, RACH related information, an antenna port muting pattern identity, and port related information in the indication information. Specific content to be viewed may be configured in advance by the network side device or is predefined. For example, a start bit of the content to be viewed by the terminal in the indication information is: a start bit of a CSI reporting configuration of a serving cell identity (serving cell Id) in a group common DCI payload; or a start bit of a CSI reporting configuration of a BWP Id in the group common DCI payload; or a start bit of second indication information in the group common DCI payload.

Optionally, the search space configuration includes at least one of the following: an offset of a Physical Downlink Control Channel (PDCCH) on a monitoring period and a time domain; and a number of PDCCH candidate resources of different aggregation levels.

Herein, the aggregation level is denoted as L_{NES}, the number of PDCCH candidate resources is

$${M}_{p , s}^{( {L}_{NES} )} ,$$

p represents a control resource set (CORESET) p, and s represents a search space set s.

Optionally, a sending manner of the indication information includes: sending periodically or sending on demand.

Sending periodically refers to that the network side device may send the indication information, such as send group common DCI, in each predefined period. The network side device configures, through RRC, a UE to monitor the group common DCI in one or more serving cells, and the UE monitors

$${M}_{p , s}^{( {L}_{NES} )}$$

PDCCH candidates with an aggregation level of L_{NES} Control Channel Element (CCE) on search space set s in which the DCI is located and corresponding CORESET P.

Optionally, the method further includes:
in a case that the indication information is not received within a second time interval, performing, by the terminal, one of the following:
performing CSI reporting based on latest received indication information; and
performing CSI reporting based on a default configuration.

Herein, the second time interval may be configured in advance by the network side device, or is predefined. For example, the second time interval is equal to the period of the indication information, and if the terminal does not receive the indication information within a period, the terminal performs CSI reporting based on the latest received indication information, or performs CSI reporting based on a default configuration.

The default configuration may be a configuration associated with a normal state (non-energy-saving state) or an energy-saving state of the network side device. The default configuration is similar to the indication information, and includes one or more of the following: a serving cell identity, a BWP identity, first indication information, CSI-RS related information, third indication information, power offset related information, second indication information, RACH related information, an antenna port muting pattern identity, and port related information. It is assumed that when the network side device sends an energy-saving indication Index, such as Index0 mapped to CSI-ReportConfig0 (energy-saving state 0), Index1 mapped to CSI-ReportConfig1 (energy-saving state 1), and Index2 mapped to CSI-ReportConfig2 (normal state/non-energy-saving state), if the network side device indicates Index0 in T1 time period, the terminal performs CSI reporting based on CSI-ReportConfig 0, and if the UE does not receive the indication information of the network side device in T2 time period, the terminal performs CSI reporting based on a configuration of non-energy-saving state (namely, CSI-ReportConfig2).

Certainly, in a case that the indication information is not received within the second time interval, the terminal may also remain unchanged.

In addition, in this embodiment, when the indication information indicates to perform activation or deactivation with CSI-ReportConfig as granularity, different CSI report configurations associated with different resource sets (with different port numbers) are activated/deactivated through L1/L2 signaling. It can be directly indicated by the third indication information (namely, an Id directly indicating the CSI report configuration), directly indicated by the second indication information (namely, indicating mapping between second indication information and a CSI report configuration), and also indicated by one or more of the fourth indication information to the seventh indication information (namely, indicating activation/deactivation of one or more resource sets in a CSI report configuration) in an associated manner.

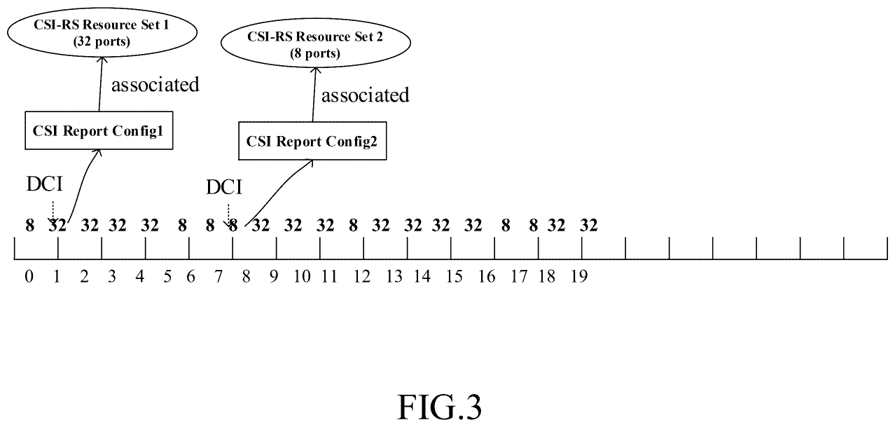

For example, as shown in FIG. 3, when the number of ports of the network side device is about to change from 8 ports to 32 ports, DCI is used to activate CSI Report Config1; and when the number of ports of the network side device is about to change from 32 ports to 8 ports, DCI is used to deactivate CSI Report Config1 and activate CSI Report Config2.

Next, the DCI is used as an example to describe how to activate or deactivate one or more specific CSI-ReportConfigs.
(1) Manner 1: DCI includes the third indication information, and CSI-ReportConfigId is directly indicated in DCI, where
behavioral meaning of CSI-ReportConfig indicated by DCI may be specified in advance, that is, whether the meaning of indication in DCI is to activate (can also be understood as enable) the CSI-ReportConfig or to deactivate (can also be understood as disable) the CSI-ReportConfig is specified in advance. That is, DCI does not necessarily need to carry the first indication information (indication of enabling or disabling CSI-ReportConfig).
(2) Manner 2: DCI includes the fifth indication information, and the CSI-ReportConfig is indicated by indicating CSI-ResourceConfigId associated with CSI-ReportConfig in DCI:
   for example, resourcesForChannelMeasurement CSI-ResourceConfigId=0 associated with CSI-ReportConfig 0, and resourcesForChannelMeasurement CSI-ResourceConfigId=1 associated with CSI-ReportConfig 1;
if a configuration of CSI-ResourceConfigId=0 is indicated to be deactivated, CSI-ReportConfig 0 does not need to be reported;
   for example, resourcesForChannelMeasurement CSI-ResourceConfigId=0 and 1 associated with CSI-ReportConfig 0, and the report may report two pieces of CSI for ResourceConfigId=0 and 1 respectively; and resourcesForChannelMeasurement CSI-ResourceConfigId=2 and 3 associated with CSI-ReportConfig 1, and the report may report two pieces of CSI for ResourceConfigId=2 and 3 respectively;
if a configuration of CSI-ResourceConfigId=0 is indicated to be deactivated, CSI for CSI-ResourceConfigId=0 in CSI-ReportConfig 0 does not need to be reported; and
if a configuration of CSI-ResourceConfigId=2 and 3 is indicated to be deactivated, CSI-ReportConfig 1 does not need to be reported.
(3) Manner 3: DCI includes the fourth indication information, and NZP-CSI-RS-ResourceSet of CSI-ResourceConfig associated with CSI-ReportConfig is indicated in DCI:
   for example, resources ForChannelMeasurement CSI-ResourceConfigId=0 associated with CSI-ReportConfig 0, and NZP-CSI-RS-ResourceSetId=0 associated with CSI-ResourceConfigId=0; and resourcesForChannelMeasurement CSI-ResourceConfigId=1 associated with CSI-ReportConfig 1, and NZP-CSI-RS-ResourceSetId=1 associated with CSI-ResourceConfigId=1;
if NZP-CSI-RS-ResourceSetId=0 is indicated to be deactivated, CSI-ReportConfig 0 does not need to be reported;
   for example, resources ForChannelMeasurement CSI-ResourceConfigId=0 associated with CSI-ReportConfig 0, and NZP-CSI-RS-ResourceSetId=0 and 1 associated with CSI-ResourceConfigId=0, the report may report two pieces of CSI for setId=0 and setId=1 respectively; and resourcesForChannelMeasurement CSI-ResourceConfigId=1 associated with CSI-ReportConfig 1, and NZP-CSI-RS-ResourceSetId=1 and 2 associated with CSI-ResourceConfigId=1, the report may report two pieces of CSI for setId=1 and setId=2 respectively; and
if NZP-CSI-RS-ResourceSetId=1 is indicated to be deactivated, CSI-ReportConfig 0 does not need to report CSI obtained by measuring NZP-CSI-RS-ResourceSetId=1, and CSI-ReportConfig 1 does not need to report CSI obtained by measuring NZP-CSI-RS-ResourceSetId=1. Alternatively, as long as one of resource sets associate with resource config is deactivated, report config corresponding to the resource config does not need to be reported.
(4) Manner 4: DCI includes the second indication information (index), and an association is established between index indicated by DCI and CSI-ReportConfig:
   for example, RRC configures three report configurations: CSI-ReportConfigId=2, CSI-ReportConfigId=3, and CSI-ReportConfigId=4, and index of DCI and CSI-ReportConfigId can be mapped one by one in the following manners:
implicit rule: Index in DCI and CSI-ReportConfigId are mapped one by one in ascending order (or in descending order), that is, Index0 in DCI represents CSI-ReportConfigId=2, Index1 represents CSI-ReportConfigId=3, and Index2 represents CSI-ReportConfigId=4;
explicit configuration: a high level configures a connection between index indicated by DCI and CSI-ReportConfigId in advance; and
RRC configures Index0 to represent CSI-ReportConfigId=3, Index1 to represent CSI-ReportConfigId=2, and Index2 to represent CSI-ReportConfigId=4. In this case, if DCI indicates Index1, it represents that CSI-ReportConfigId=2 is activated/deactivated.

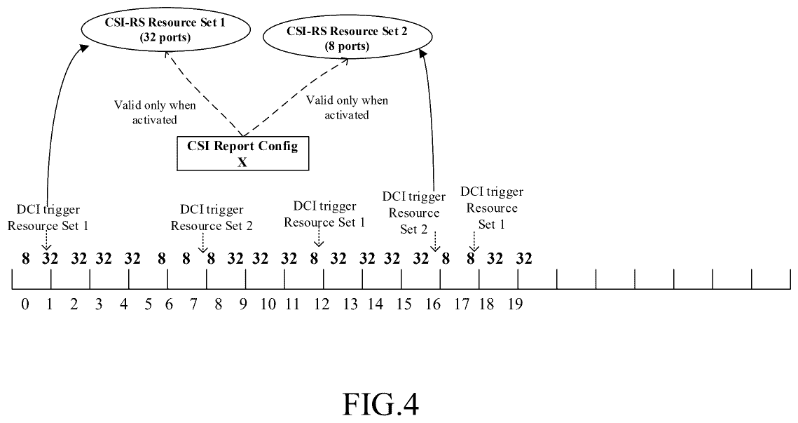

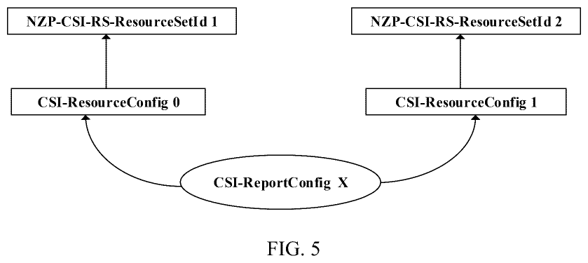

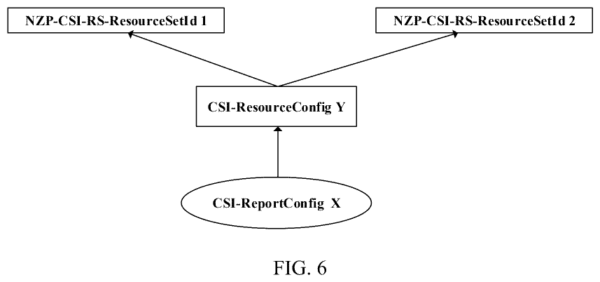

In addition, in this embodiment, when the indication information indicates to perform activation or deactivation with NZP-CSI-RS-ResourceSet/CSI-ResourceConfig as granularity, different CSI-RS resource sets (with different port numbers) in a report configuration can be activated/disabled through L1/L2 signaling. Two operations can be:
Opt 1: Modify CSI-ReportConfig to allow one CSI-ReportConfig to be associated with a plurality of CSI-ResourceConfigs, and indicate corresponding CSI-ResourceConfig to be activated/deactivated, to indicate corresponding CSI-RS Resource set to be activated/deactivated, as shown in FIG. 4 and FIG. 5; and
CSI-RS used for channel measurement is used as an example. resourcesForChannelMeasurement in CSI-ReportConfig is modified into a list, and each entry in the list includes one or more CSI-ResourceConfigs. Certainly, CSI-RS used for CSI interference measurement and CSI-RS used for interference measurement in an MU-MIMO (Multi User MIMO) scenario are also optionally configured as a list.
Opt 2: Allow resource configuration to be associated with S≥1 resource sets, support port adaptation by indicating corresponding NZP-CSI-RS-ResourceSetId to be activated/deactivated, and allow one or more NZP-CSI-RS-ResourceSets to be activated at a time, as shown in FIG. 4 and FIG. 6.

Herein, for activation or deactivation with NZP-CSI-RS-ResourceSet as granularity, it can be directly indicated by the fourth indication information, directly indicated by the second indication information, and also indicated by one or more of the third indication information, the fifth indication information, the sixth indication information, or the seventh indication information in an associated manner. For CSI-ResourceConfig granularity, it can be directly indicated by the fifth indication information, directly indicated by the second indication information, and also indicated by one or more of the third indication information, the fourth indication information, the sixth indication information, or the seventh indication information in an associated manner.

Next, the DCI is used as an example to describe how to activate or deactivate one or more specific CSI-ResourceConfigs.
(1) Manner 1: DCI includes the fifth indication information, and CSI-ResourceConfigId is directly indicated in DCI, where
behavioral meaning of CSI-ResourceConfig indicated by DCI may be specified in advance by a protocol, that is, whether the meaning of indication in DCI is to enable the CSI-ResourceConfig or to disable the CSI-ResourceConfig is specified in advance. That is, DCI does not necessarily need to carry the first indication information (indication of enabling or disabling CSI-ResourceConfig).
(2) Manner 2: DCI includes the fourth indication information, and the CSI-ResourceConfig is indicated by indicating NZP-CSI-RS-ResourceSetId associated with CSI-ResourceConfig in DCI:
   for example, NZP-CSI-RS-ResourceSetId=0 and 1 associated with CSI-ResourceConfig 0, and the report associated with the resource config may report two pieces of CSI for setId=0 and setId=1 respectively; and NZP-CSI-RS-ResourceSetId=1 and 2 associated with CSI-ResourceConfig 1, and the report associated with the resource config may report two pieces of CSI for setId=1 and setId=2 respectively; and
if NZP-CSI-RS-ResourceSetId=1 is indicated to be deactivated, report associated with CSI-ResourceConfig 0 to which the set1 belongs may not report CSI for set1, but report CSI only for set0; and report associated with CSI-ResourceConfig 1 to which the set1 belongs may not report CSI for set1, but report CSI only for set2. Alternatively, as long as one of sets associated with resource config is deactivated, reporting corresponding to the resource config is cancelled. In this example, as long as set1 is deactivated, both CSI-ResourceConfig 0 and CSI-ResourceConfig 1 may cancel corresponding CSI reporting.
(3) Manner 3: DCI includes the second indication information (index), and an association is established between index indicated by DCI and CSI-ResourceConfig ID:
   for example, RRC configures three resource configurations: CSI-ResourceConfigId=2, CSI-ResourceConfigId=3, and CSI-ResourceConfigId=4, and index of DCI and CSI-ResourceConfigId can be mapped one by one in the following manners:
implicit rule: Index in DCI and CSI-ResourceConfigId are mapped one by one in ascending order/in descending order, that is, Index0 in DCI represents CSI-ResourceConfigId=2, Index1 represents CSI-CSI-ResourceConfigId=3, and Index2 represents CSI-ResourceConfigId=4;
explicit configuration: a high level configures a connection between index indicated by DCI and CSI-ResourceConfigId in advance; and
RRC configures Index0 to represent CSI-ResourceConfigId=3, Index1 to represent CSI-CSI-ResourceConfigId=2, and Index2 to represent CSI-ResourceConfigId=4. In this case, if DCI indicates Index1, it represents that CSI-ResourceConfigId=2 is activated/deactivated.

Next, the DCI is used as an example to describe how to activate or deactivate one or more specific NZP-CSI-RS-ResourceSets.
(1) Manner 1: DCI includes the fourth indication information, and NZP-CSI-RS-ResourceSetId is directly indicated in DCI, where
behavioral meaning of NZP-CSI-RS-ResourceSet indicated by DCI may be specified in advance, that is, whether the meaning of indication in DCI is to enable the NZP-CSI-RS-ResourceSet or to disable the NZP-CSI-RS-ResourceSet is specified in advance. That is, DCI does not necessarily need to carry the first indication information (indication of enabling or disabling NZP-CSI-RS-ResourceSet).
(2) Manner 2: DCI includes the second indication information (index), and an association is established between index indicated by DCI and NZP-CSI-RS-ResourceSetId:
   for example, RRC configures three resource set configurations: NZP-CSI-RS-ResourceSetId=2, NZP-CSI-RS-ResourceSetId=3, and NZP-CSI-RS-ResourceSetId=4, and index of DCI and NZP-CSI-RS-ResourceSetId can be mapped one by one in the following manners:
implicit rule: Index in DCI and NZP-CSI-RS-ResourceSetId are mapped one by one in ascending order/in descending order, that is, Index0 in DCI represents NZP-CSI-RS-ResourceSetId=2, Index1 represents NZP-CSI-RS-ResourceSetId=3, and Index2 represents NZP-CSI-RS-ResourceSetId=4;
explicit configuration: a high level configures a connection between index indicated by DCI and NZP-CSI-RS-ResourceSetId in advance:
RRC configures Index0 to represent NZP-CSI-RS-ResourceSetId=3, Index1 to represent NZP-CSI-RS-ResourceSetId=2, Index2 to represent NZP-CSI-RS-ResourceSetId=4, and Index3 to represent NZP-CSI-RS-ResourceSetId=2 and 3:
if DCI indicates Index1, it represents that NZP-CSI-RS-ResourceSetId=2 is activated/deactivated; and
if DCI indicates Index3, it represents that NZP-CSI-RS-ResourceSetId=2 and 3 is activated/deactivated.

In addition, in this embodiment, when the indication information indicates to perform activation or deactivation with NZP-CSI-RS-Resource (group) as granularity, different CSI-RS resource groups (with different port numbers) can be activated/deactivated through L1/L2 signaling. It can be directly indicated by the seventh indication information, directly indicated by the second indication information, and also indicated by one or more of the third indication information to the sixth indication information in an associated manner.

For example, as shown in the figure, RRC configures NZP-CSI-RS-ResourceSet4 in CSI Report Config X to be associated with a plurality of CSI-RS Resources, and allows different resources to have different port numbers:
when the number of ports of the network side device is about to change from 8 ports to 32 ports, DCI is used to activate CSI Resource #0, 1, 2, 3 (resource group Id=0), and deactivate all other resources; and
when the number of ports of the network side device is about to change from 32 ports to 8 ports, DCI is used to activate CSI-RS Resource 4, 5, 6, 7 (resource group Id=1), and deactivate all other resources.

Certainly, only some of the manners in the foregoing examples are realized. Details are not described herein again.

Correspondingly, corresponding to specific content of the indication information, implementations of CSI reporting performed by the terminal based on the indication information are different.

Optionally, the performing, by the terminal, CSI reporting based on the indication information includes:
in a case that the indication information indicates to activate or deactivate at least one CSI reporting configuration, reporting or stopping reporting, by the terminal, CSI based on a first CSI reporting configuration, where
the first CSI reporting configuration is at least one CSI reporting configuration that the indication information indicates to activate or deactivate.

Herein, at least one CSI reporting configuration that the indication information indicates to activate or deactivate, that is, the first CSI reporting configuration, may correspond to a case in which the indication information includes the third indication information or the second indication information (the second indication information is mapped with at least one CSI reporting configuration). In this case, the terminal can directly report or stop reporting CSI based on the first CSI reporting configuration. For example, if DCI carries the third indication information, to indicate to activate CSI-ReportConfig0, the terminal reports CSI for CSI-ReportConfig0.

Optionally, the performing, by the terminal, CSI reporting based on the indication information includes:
in a case that the indication information indicates to activate or deactivate at least one CSI-RS resource configuration, the terminal:
reporting or stopping reporting CSI based on a second CSI reporting configuration; or
reporting or stopping reporting CSI based on a first CSI-RS resource configuration, where
the second CSI reporting configuration is a CSI reporting configuration corresponding to the first CSI-RS resource configuration; and the first CSI resource configuration is at least one CSI-RS resource configuration that the indication information indicates to activate or deactivate.

Herein, at least one CSI-RS resource configuration that the indication information indicates to activate or deactivate, that is, the first CSI-RS resource configuration, may correspond to a case in which the indication information includes the fifth indication information or the second indication information (the second indication information is mapped with at least one CSI-RS resource configuration). Certainly, the first CSI-RS resource configuration can also be a second-level indication. For example, the indication information includes the third indication information and the fifth indication information, indicating to activate or deactivate which CSI-RS resource configuration associated with which CSI reporting configuration.

In this case, on the one hand, the terminal may directly use the first CSI-RS resource configuration to report or stop CSI for the first CSI-RS resource configuration. For example, DCI carries the fifth indication information to indicate to activate CSI-ResourceConfig 1, and the terminal reports CSI for CSI-ResourceConfig 1. On the other hand, a CSI reporting configuration corresponding to the first CSI-RS resource configuration, that is, the second CSI reporting configuration, reports or stops CSI for the second CSI reporting configuration, for example, resourcesForChannelMeasurement CSI-ResourceConfigId=0 associated with CSI-ReportConfig 0, resources ForChannelMeasurement CSI-ResourceConfigId=1 associated with CSI-ReportConfig 1. If the DCI carries the fifth indication information, to indicate a configuration of CSI-ResourceConfigId=0 to be deactivated, the terminal does not need to report CSI based on CSI-ReportConfig 0.

Optionally, the performing, by the terminal, CSI reporting based on the indication information includes:
in a case that the indication information indicates to activate or deactivate at least one CSI-RS resource set, the terminal:
reporting or stopping reporting CSI based on a third CSI reporting configuration; or
reporting or stopping reporting CSI based on a second CSI-RS resource configuration; or
reporting or stopping reporting CSI based on a first CSI-RS resource set, where
the third CSI reporting configuration is a CSI reporting configuration corresponding to the second CSI-RS resource configuration, the second CSI-RS resource configuration is a CSI-RS resource configuration corresponding to the first CSI-RS resource set, and the first CSI-RS resource set is at least one CSI-RS resource set that the indication information indicates to activate or deactivate.

Herein, at least one CSI-RS resource set that the indication information indicates to activate or deactivate, that is, the first CSI-RS resource set, may correspond to a case in which the indication information includes the fourth indication information or the second indication information (the second indication information is mapped with at least one CSI-RS resource set). Certainly, the first CSI-RS resource set can also be a second-level indication. For example, the indication information includes the fifth indication information and the fourth indication information, indicating to activate or deactivate which CSI-RS resource set associated with which CSI reporting configuration; and can also be a third-level indication. For example, the indication information includes the third indication information, the fifth indication information, and the fourth indication information.

In this case, on the one hand, the terminal may directly use the first CSI-RS resource set to report or stop CSI for the first CSI-RS resource set. For example, DCI carries the fourth indication information to indicate to activate NZP-CSI-RS-ResourceSet 1, and the terminal reports CSI for NZP-CSI-RS-ResourceSet 1.

On the other hand, a CSI resource configuration corresponding to the first CSI-RS resource set, that is, the second CSI-RS resource configuration, reports or stops CSI associated with the second CSI-RS resource configuration,
for example, resourcesForChannelMeasurement CSI-ResourceConfigId=0 associated with CSI-ReportConfig 0, and NZP-CSI-RS-ResourceSetId=0 associated with CSI-ResourceConfigId=0; and resourcesForChannelMeasurement CSI-ResourceConfigId=1 and 2 associated with CSI-ReportConfig 1, NZP-CSI-RS-ResourceSetId=1 and 2 associated with CSI-ResourceConfigId=1, and NZP-CSI-RS-ResourceSetId=3 associated with CSI-ResourceConfigId=2;
in the foregoing example, if the DCI carries the fourth indication information, indicating that NZP-CSI-RS-ResourceSetId=1 is deactivated, then:
   CSI-ReportConfig 0 is reported normally without being affected; and
   when CSI is reported based on CSI-ReportConfig 1, CSI obtained by measuring NZP-CSI-RS-ResourceSetId=1 does not need to be reported, that is, CSI-ReportConfig 1 does not need to report CSI obtained from corresponding CSI-ResourceConfigId=1 based on set1, and reporting of CSI obtained from CSI-ResourceConfigId=2 corresponding to CSI-ReportConfig 1 is not affected; or because CSI-ResourceConfigId=1 is associated with NZP-CSI-RS-ResourceSetId=1, CSI for CSI-ResourceConfigId=1 does not need to be reported.

On the other hand, a CSI reporting configuration corresponding to the second CSI-RS resource configuration, that is, the third CSI reporting configuration, reports or stops CSI for the third CSI reporting configuration, for example, resourcesForChannelMeasurement CSI-ResourceConfigId=0 associated with CSI-ReportConfig 0, and NZP-CSI-RS-ResourceSetId=0 associated with CSI-ResourceConfigId=0; resourcesForChannelMeasurement CSI-ResourceConfigId=1 and 2 associated with CSI-ReportConfig 1, NZP-CSI-RS-ResourceSetId=1 and 2 associated with CSI-ResourceConfigId=1, and NZP-CSI-RS-ResourceSetId=3 associated with CSI-ResourceConfigId=2; if DCI carries the fourth indication information, indicating that NZP-CSI-RS-ResourceSetId=3 is deactivated, the terminal does not need to report CSI obtained by measuring NZP-CSI-RS-ResourceSetId=3, that is, CSI associated with CSI-ResourceConfigId=2 in CSI-ReportConfig1 does not need to be reported; or CSI obtained by measuring NZP-CSI-RS-ResourceSetId=1, 2, and 3 does not need to be reported, that is, CSI-ReportConfig 1 does not need to report CSI.

Optionally, the performing, by the terminal, CSI reporting based on the indication information includes:
in a case that the indication information indicates to activate or deactivate at least one CSI-RS resource, the terminal:
reporting or stopping reporting CSI based on a fourth CSI reporting configuration; or
reporting or stopping reporting CSI based on a third CSI-RS resource configuration; or
reporting or stopping reporting CSI based on a second CSI-RS resource set; or
reporting or stopping reporting CSI based on a first CSI-RS resource, where
the fourth CSI reporting configuration is a CSI reporting configuration corresponding to the third CSI-RS resource configuration, the third CSI-RS resource configuration is a CSI-RS resource configuration corresponding to the second CSI-RS resource set, the second CSI-RS resource set is a resource set to which the first CSI-RS resource belongs, and the first CSI-RS resource is at least one CSI-RS resource that the indication information indicates to activate or deactivate.

Herein, at least one CSI-RS resource that the indication information indicates to activate or deactivate, that is, the first CSI-RS resource, may correspond to a case in which the indication information includes the sixth indication information or the second indication information (the second indication information is mapped with at least one CSI-RS resource). Certainly, the first CSI-RS resource can also be a second-level indication. For example, the indication information includes the fourth indication information and the sixth indication information, indicating to activate or deactivate which CSI-RS resource of which CSI-RS resource set; can also be a third-level indication. For example, the indication information includes the fifth indication information, the fourth indication information, and the sixth indication information; and can also be a fourth-level indication. For example, the indication information includes the third indication information, the fifth indication information, the fourth indication information, and the sixth indication information.

In this case, on the one hand, the terminal may directly use the first CSI-RS resource to report or stop CSI for the first CSI-RS resource. For example, DCI carries the sixth indication information to indicate to activate NZP-CSI-RS-Resource 1, and the terminal reports CSI for NZP-CSI-RS-Resource 1.

On the one hand, a CSI-RS resource set corresponding to the first CSI-RS resource, that is, the second CSI-RS resource set, reports or stops CSI for the second CSI-RS resource set, for example, resourcesForChannelMeasurement CSI-ResourceConfigId=0 associated with CSI-ReportConfig 0, and NZP-CSI-RS-ResourceSetId=0 associated with CSI-ResourceConfigId=0, where NZP-CSI-RS-ResourceSetId=0 includes NZP-CSI-RS-ResourceId=0; resourcesForChannelMeasurement CSI-ResourceConfigId=1 and 2 associated with CSI-ReportConfig 1, NZP-CSI-RS-ResourceSetId=1 and 2 associated with CSI-ResourceConfigId=1, where NZP-CSI-RS-ResourceSetId=1 includes NZP-CSI-RS-ResourceId=2 and 3, and NZP-CSI-RS-ResourceSetId=2 includes NZP-CSI-RS-ResourceId=4, and NZP-CSI-RS-ResourceSetId=3 associated with CSI-ResourceConfigId=2, where NZP-CSI-RS-ResourceSetId=3 includes NZP-CSI-RS-ResourceId=5; and if DCI carries the sixth indication information, indicating that NZP-CSI-RS-ResourceId=2 is deactivated,
CSI-ReportConfig 0 is reported normally without being affected;
the UE does not need to report CSI obtained by measuring NZP-CSI-RS-ResourceId=2, that is, CSI-ReportConfig 1 does not need to report CSI obtained from NZP-CSI-RS-ResourceId=2 corresponding to CSI-ResourceConfigId=1, and CSI obtained from NZP-CSI-RS-ResourceId=3 corresponding to CSI-ResourceConfigId=1 is reported normally; or because resourceId=2 belongs to set1, CSI for set1 does not need to be reported; and
CSI-ReportConfig 1 continues to report CSI obtained from NZP-CSI-RS-ResourceSetId=3 corresponding to CSI-ResourceConfigId=2.

On the one hand, a CSI-RS resource configuration corresponding to the second CSI-RS resource set, that is, the third CSI-RS resource configuration, reports or stops CSI for the third CSI-RS resource configuration, for example, resourcesForChannelMeasurement CSI-ResourceConfigId=0 associated with CSI-ReportConfig 0, and NZP-CSI-RS-ResourceSetId=0 associated with CSI-ResourceConfigId=0, where NZP-CSI-RS-ResourceSetId=0 includes NZP-CSI-RS-ResourceId=0; resourcesForChannelMeasurement CSI-ResourceConfigId=1 and associated with CSI-ReportConfig 1, NZP-CSI-RS-ResourceSetId=1 and 2 associated with CSI-ResourceConfigId=1, where NZP-CSI-RS-ResourceSetId=1 includes NZP-CSI-RS-ResourceId=2 and 3, and NZP-CSI-RS-ResourceSetId=2 includes NZP-CSI-RS-ResourceId=4, and NZP-CSI-RS-ResourceSetId=3 associated with CSI-ResourceConfigId=2, where NZP-CSI-RS-ResourceSetId=3 includes NZP-CSI-RS-ResourceId=5; and if DCI carries the sixth indication information, indicating that NZP-CSI-RS-ResourceId=2 is deactivated, the terminal reports CSI based on CSI-ReportConfig 0, and does not need to report CSI obtained by measuring NZP-CSI-RS-ResourceId=2, 3, and 4, that is, CSI-ReportConfig 1 does not need to report CSI obtained from corresponding CSI-ResourceConfigId=1, and CSI-ReportConfig 1 reports CSI obtained from corresponding CSI-ResourceConfigId=2.

On the other hand, a CSI-RS resource configuration corresponding to the third CSI-RS resource set, that is, the fourth CSI reporting configuration, reports or stops CSI configured for the fourth CSI reporting configuration, for example, resourcesForChannelMeasurement CSI-ResourceConfigId=0 associated with CSI-ReportConfig 0, and NZP-CSI-RS-ResourceSetId=0 associated with CSI-ResourceConfigId=0, where NZP-CSI-RS-ResourceSetId=0 includes NZP-CSI-RS-ResourceId=0; resourcesForChannelMeasurement CSI-ResourceConfigId=1 and 2 associated with CSI-ReportConfig 1, and NZP-CSI-RS-ResourceSetId=1 and 2 associated with CSI-ResourceConfigId=1, where NZP-CSI-RS-ResourceSetId=1 includes NZP-CSI-RS-ResourceId=2 and 3, and NZP-CSI-RS-ResourceSetId=2 includes NZP-CSI-RS-ResourceId=4, and NZP-CSI-RS-ResourceSetId=3 associated with CSI-ResourceConfigId=2, where NZP-CSI-RS-ResourceSetId=3 includes NZP-CSI-RS-ResourceId=5; and if DCI carries the sixth indication information, indicating that NZP-CSI-RS-ResourceId=2 is deactivated, the terminal reports CSI based on CSI-ReportConfig 0, and does not need to report CSI obtained by measuring NZP-CSI-RS-ResourceId=2, 3, 4, and 5, that is, CSI-ReportConfig 1 does not need to report CSI.

In this embodiment, a case in which the indication information indicates to activate or deactivate at least one CSI-RS resource group is similar to the foregoing case in which the indication information indicates to activate or deactivate at least one CSI-RS resource. Details are not described herein again. A CSI-RS resource group can be indicated by using a group identity.

In the foregoing embodiments, there are the following rules, which are explained by a concept range size report config>resource config>resource set>resource: when activating or deactivating a concept with a small range, there are two understandings, one is that CSI with the small range is activated or deactivated, and the other is that a concept of an upper level/upper two levels/upper three levels to which the small range belongs is activated or deactivated. For example, deactivating a resource set is used as an example, it can be understood as that CSI corresponding to the set is deactivated, that an upper level of the set level (namely, resource config associated with the set) is deactivated, and even that upper two levels of the set (namely, report config associated with resource config corresponding to the set) are deactivated. The rest is the same.

Optionally, in this embodiment, the performing, by the terminal, CSI reporting based on the indication information includes:
in a case of reporting or stopping reporting CSI based on a fourth CSI-RS resource configuration, reporting or stopping reporting, by the terminal, CSI based on a state of the fourth CSI-RS resource configuration, where the fourth CSI-RS resource configuration is at least one of the following: a first type of CSI-RS resource configuration, a second type of CSI-RS resource configuration, and a third type of CSI-RS resource configuration; or
in a case of reporting or stopping reporting CSI based on a third CSI-RS resource set, reporting or stopping reporting, by the terminal, CSI based on a state of the third CSI-RS resource set, where a CSI-RS resource configuration to which the third CSI-RS resource set belongs is at least one of the following: a first type of CSI-RS resource configuration, a second type of CSI-RS resource configuration, and a third type of CSI-RS resource configuration, where
the first type of CSI-RS resource configuration is used for channel measurement; the second type of CSI-RS resource configuration is used for CSI interference measurement; and the third type of CSI-RS resource configuration is used for interference measurement in an MU-MIMO scenario.

Herein, the fourth CSI-RS resource configuration may be indicated by the indication information (including first-level indication (direct indication) and multi-level indication), and may be associated with specific information in the indication information (such as a CSI-RS resource configuration associated with a CSI-RS resource set indicated by the fourth indication information, that is, the fourth CSI-RS resource configuration). Similarly, the third CSI-RS resource set may be indicated by the indication information (including the first-level indication and the multi-level indication), and may be associated with specific information in the indication information (such as a CSI-RS resource set associated with a CSI-RS resource indicated by the sixth indication information, that is, the third CSI-RS resource set).

The first type of CSI-RS resource configuration is CSI-ResourceConfig of resourcesForChannelMeasurement, the second type of CSI-RS resource configuration is CSI-ResourceConfig of csi-IM-ResourcesForInterference, and the third type of CSI-RS resource configuration is CSI-ResourceConfig of nzp-CSI-RS-ResourcesForInterference.

According to the classification of protocols, this application can activate or deactivate corresponding CSI-ResourceConfig and associated CSI-RS Resource (Set) based on a first type of Channel Measurement Resource (CMR), can also configure/activate/deactivate corresponding CSI-ResourceConfig and associated CSI-RS Resource (Set) based on a second type of Interference Measurement Resource (IMR), can also configure/activate/deactivate corresponding CSI-ResourceConfig and associated CSI-RS Resource (Set) based on an interference measurement resource in a third type of MU-MIMO scenario; and can also perform activation or deactivation based on one of the foregoing three types or a combination of two or three types.

For example, the network side configures one report config to be associated with interference measurement resources of two CMRs, one IMR, and one MU-MIMO, and it can be specified that a plurality of pieces of CSI can be reported based on a number of activated CMRs; CSI can be reported based on a number of activated (CMR, IMR) combinations (one in this example); and CSI can also be reported based on a number of activated (CMR, IMR, MU-MIMO interference) combinations (one in this example).

It can be learned that the indication information field in this application can indicate the resources of CMR and resources of IMR, and some rules can be specified, for example, only a resource indicating CMR represents activation/deactivation of corresponding CSI reporting/non-reporting, or only a combination of indication (CMR+IMR) represents activation/deactivation of corresponding CSI reporting/non-reporting.

Optionally, an information field of the signaling is used for one or more terminals.

Herein, the information field carries one or more of the following: a serving cell identity, a BWP identity, first indication information, CSI-RS related information, third indication information, power offset related information, second indication information, RACH related information, an antenna port muting pattern identity, and port related information.

In this embodiment, an example in which the group common DCI carries the indication information is used. The group common DCI notifies activated/deactivated CSI report config (CSI-ReportConfig), CSI resource configId (CSI-ResourceConfig), CSI resource set (NZP-CSI-RS-ResourceSet), CSI-RS resource (NZP-CSI-RS-Resource) positionInDCI and payloadsize of each configured servingcell (or activated servingcell) of each UE, which is configured by RRC to describe to DCI as follows.

### Example 1: For DCI of UE in a Cell, RRC Configures a Serving Cell Applied (Apply) by the DCI

Opt-1-1: Direct indication.
Opt-1-1-1: DCI directly indicates enabled or disabled CSI-ReportConfigId (with maximum flexibility), as shown in Table 1-1 below:

TABLE 1-1

| Group common DCI information field | |
|---|---|
| (Group common DCI fields) | Value |
| CSI-ReportConfigId | Integer (0 . . . maxNrofCSI- |
| | ReportConfigurations) |

In this case, a number of bits occupied is related to a maximum number of CSI-Report configurations that can be supported.
Opt-1-1-2: DCI directly indicates enabled or disabled CSI-ResourceConfigId, as shown in Table 1-2 below:

TABLE 1-2

| Group common DCI fields | Value |
|---|---|
| CSI-ResourceConfigId | Integer (0 . . . maxNrofCSI- |
| | ResourceConfigurations) |

In this case, a number of bits occupied is related to a maximum number of CSI-Resource configurations that can be supported.
Opt-1-1-3: DCI directly indicates enabled or disabled NZP-CSI-RS-ResourceSetId, as shown in Table 1-3 below:

TABLE 1-3

| Group common DCI fields | Value |
|---|---|
| NZP-CSI-RS-ResourceSetId | Integer (0 . . . maxNrofNZP-CSI-RS- |
| | ResourceSets) |

In this case, a number of bits occupied is related to a maximum number of CSI-RS resource sets that can be supported.
Opt-1-1-4: DCI directly indicates enabled or disabled NZP-CSI-RS-ResourceGroupId, as shown in Table 1-4 below:

TABLE 1-4

| Group common DCI fields | Value |
|---|---|
| NZP-CSI-RS-ResourceGroupId | Integer (0 . . . maxNrofNZP-CSI-RS- |
| | ResourceGroups) |

Opt-1-1-5: DCI directly indicates enabled or disabled one entry of NZP-CSI-RS-ResourceSetList, that is, RRC configuration gives a list, each entry in the list includes one or more NZP-CSI-RS-ResourceSetIds, and DCI only needs to indicate one or more entries, as shown in Table 1-5 below:

TABLE 1-5

| Group common DCI fields | Value |
|---|---|
| one entry of NZP-CSI-RS-ResourceSetList | Entry index |

In this case, a number of bits occupied is related to a maximum number of NZP-CSI-RS-ResourceSetLists that can be supported.

Similarly, DCI can also directly indicate enabled or disabled one entry of NZP-CSI-RS-ReportConfigList/one entry of NZP-CSI-RS-ResourceConfigList/one entry of NZP-CSI-RS-ResourceGroupList, not listed again.
Opt-1-2: RRC configures to indicate an association relationship between Index and one or more of CSI-ReportConfigId, CSI-ResourceConfigId, NZP-CSI-RS-ResourceSetId, and NZP-CSI-RS-ResourceGroupId in an energy-saving manner, and a mapped configuration change is indicated by using a DCI energy-saving indication Index.
Opt-1-2-1: RRC configures DCI to indicate an association relationship between Index and CSI-ReportConfigId in an energy-saving manner, and DCI indicates an energy-saving indication Index (with an advantage of reducing a DCI size):
for example, the association relationship between Index and CSI-ReportConfigId configured by RRC for the UE to indicate in an energy-saving manner is shown in Table 1-6 below:

TABLE 1-6

| DCI energy-saving indication | |
|---|---|
| Index value | CSI-ReportConfigId |
| 0 | 12 |
| 1 | 56 |
| . . . | . . . |

DCI indication is as shown in Table 1-7 below:

TABLE 1-7

| Group common DCI fields | Value |
|---|---|
| DCI energy-saving indication | Integer (0 . . . A) |
| Index (The number of bits can | A refers to a maximum allowable DCI |
| be determined based on A) | Index value, and the size of A is |
| | related to the table size configured |
| | by RRC above. |

When the DCI energy-saving indication Index indicates value=0, it means that the configuration of CSI-ReportConfigId=12 is activated/deactivated; and when the DCI energy-saving indication Index indicates value=1, it means that the configuration of CSI-ReportConfigId=56 is activated/deactivated.
Opt-1-2-2: RRC configures an association relationship between DCI energy-saving indication Index and CSI-ResourceConfigId, and when DCI indicates an energy-saving indication Index, corresponding CSI-ResourceConfig is activated/deactivated.

For example, the association relationship between Index and CSI-ResourceConfigId configured by RRC for the UE to indicate in an energy-saving manner is shown in Table 1-8 below:

TABLE 1-8

| DCI energy-saving indication | |
|---|---|
| Index value | CSI-ResourceConfigId |
| 0 | 30 |
| 1 | 60 |
| . . . | . . . |

DCI indication is as shown in Table 1-9 below:

TABLE 1-9

| Group common DCI fields | Value |
|---|---|
| DCI energy-saving indication | Integer (0 . . . B) B refers to a |
| Index (The number of bits can | maximum allowable DCI Index value, |
| be determined based on B) | and the size of B is related to the |
| | table size configured by RRC above. |

When the DCI energy-saving indication Index indicates value=0, it means that the configuration of CSI-ResourceConfigId=30 is activated/deactivated; and when the DCI energy-saving indication Index indicates value=1, it means that the configuration of CSI-ReportConfigId=60 is activated/deactivated.
Opt-1-2-3: RRC configures DCI to indicate an association relationship between Index and NZP-CSI-RS-ResourceSetId in an energy-saving manner, and DCI indicates an energy-saving indication Index:
for example, the association relationship between Index and NZP-CSI-RS-ResourceSetId configured by RRC for the UE to indicate in an energy-saving manner is shown in Table 1-10 below:

TABLE 1-10

| DCI energy-saving indication | NZP-CSI-RS- |
|---|---|
| Index value | ResourceSetId |
| 0 | 10 |
| 1 | 12 |
| . . . | . . . |

DCI indication is as shown in Table 1-11 below:

TABLE 1-11

| Group common DCI fields | Value |
|---|---|
| DCI energy-saving indication | Integer (0 . . . C) C refers to a |
| Index (The number of bits can | maximum allowable DCI Index value, |
| be determined based on C) | and the size of C is related to the |
| | table size configured by RRC above. |

When the DCI energy-saving indication Index indicates value=0, it means that NZP-CSI-RS-ResourceSetId=10 is activated/deactivated; and when the DCI energy-saving indication Index indicates value=1, it means that NZP-CSI-RS-ResourceSetId=12 is activated/deactivated.
Opt-1-2-4: RRC configures DCI to indicate an association relationship between Index and NZP-CSI-RS-ResourceGroupId in an energy-saving manner, and DCI indicates an energy-saving indication Index:
for example, the association relationship between Index and

NZP-CSI-RS-ResourceGroupId configured by RRC for the UE to indicate in an energy-saving manner is shown in Table 1-12 below:

TABLE 1-12

| DCI energy-saving indication | NZP-CSI-RS- |
|---|---|
| Index value | ResourceGroupId |
| 0 | 10 |
| 1 | 12 |
| . . . | . . . |

DCI indication is as shown in Table 1-13 below:

TABLE 1-13

| Group common DCI fields | Value |
|---|---|
| DCI energy-saving indication | Integer (0 . . . D) D refers to a |
| Index (The number of bits | maximum allowable DCI Index value, |
| can be determined based | and the size of D is related to the |
| on D) | table size configured by RRC above. |

When the DCI energy-saving indication Index indicates value-0, it means that CSI-RS Resources in NZP-CSI-RS-ResourceGroupId=10 is activated/deactivated; and when the DCI energy-saving indication Index indicates value=1, it means that CSI-RS Resources in NZP-CSI-RS-ResourceGroupId=12 is activated/deactivated.

Note: The tables configured by RRC can also be a combination of one or more of Opt-1-2-1, Opt-1-2-2, Opt-1-2-3, and Opt-1-2-4, as shown in Table 1-14 to Table 1-17 below:

TABLE 1-14

| DCI energy-saving indication | BWP | |
|---|---|---|
| Index value | Id | CSI-ReportConfigId |
| 0 | 2 | 2 |
| 1 | 1 | 3 |
| . . . | . . . | |

TABLE 1-15

| DCI energy-saving indication | BWP | |
|---|---|---|
| Index value | Id | NZP-CSI-RS-ResourceSetId |
| 0 | 2 | 2 |
| 1 | 1 | 3 |
| . . . | . . . | |

TABLE 1-16

| DCI energy-saving indication | BWP | CSI-Re- | NZP-CSI-RS- |
|---|---|---|---|
| Index value | Id | portConfigId | ResourceSetId |
| 0 | 3 | 2 | |
| 1 | 1 | 3 | |
| . . . | . . . | | |

TABLE 1-17

| DCI energy-saving | | | | | |
|---|---|---|---|---|---|
| indication Index | CSI-Report | CSI-Resource | NZP-CSI-RS- | NZP-CSI-RS- | BWP |
| value | ConfigId | ConfigId | ResourceSetId | ResourceGroupId | Id |
| 0 | 10 | 2 | 4 | 6 | 1 |
| 1 | 12 | 3 | 4 | 2 | 3 |
| . . . | . . . | | | | |

When the DCI energy-saving indication Index indicates a corresponding value in an energy-saving manner, a corresponding configuration of this row is activated/deactivated.

Note: The energy-saving indication Index is an Index obtained by using a mapping relationship between Index and one or more of CSI-ReportConfigId, CSI-ResourceConfigId, NZP-CSI-RS-ResourceSetId, and NZP-CSI-RS-ResourceGroupId.
Opt-1-3: DCI indicates enabled/disabled report config (similar to A-CSI report trigger)+corresponding resource set (indicated bits are determined based on a number of configured resource sets), as shown in Table 1-18 to Table 1-23 below:

TABLE 1-18
Group common DCI fields

| | |
|---|---|
| CSI-ReportConfigId | NZP-CSI-RS-ResourceSetId |

TABLE 1-19
Group common DCI fields

| | |
|---|---|
| CSI-ReportConfigId = 0 | NZP-CSI-RS-ResourceSetId = 0 |

TABLE 1-20
Group common DCI fields

| | | |
|---|---|---|
| CSI-Re- | NZP-CSI-RS-Re- | NZP-CSI-RS-Re- |
| portConfigId = 0 | sourceSetId = 0 | sourceSetId = 1 |

TABLE 1-21
Group common DCI fields

| CSI-Report | NZP-CSI-RS- | NZP-CSI-RS- | CSI-Report | NZP-CSI-RS- | NZP-CSI-RS- |
|---|---|---|---|---|---|
| ConfigId = | ResourceSetId = | ResourceSetId = | ConfigId = | ResourceSetId = | ResourceSetId = |
| 0 | 0 | 1 | 1 | 4 | 5 |

TABLE 1-22
Group common DCI fields

| | |
|---|---|
| CSI-Re- | One entry of NZP-CSI-RS-ResourceSetToActivateList/ |
| portConfigId | One entry of NZP-CSI-RS-ResourceSetToDeActivateList |

TABLE 1-23
Group common DCI fields

| | One entry of NZP-CSI-RS- |
|---|---|
| CSI-ReportConfigId | ResourceSetToDeActivateList |
| 0 | 0 |

Corresponding to Table 1-23, RRC configures NZP-CSI-RS-ResourceSetToActivateList={2; 2,3,4; 2,4,6; 3,5,6,7,8}; and RRC configures NZP-CSI-RS-ResourceSet used for channel measurement in CSI-ResourceConfig associated with CSI-ReportConfigId=0 to be set0 and set2. When DCI indicates deactivated NZP-CSI-RS-ResourceSetId=0, CSI Report of CSI-ReportConfigId=0 does not need to report CSI obtained by measuring set0, and only CSI obtained by measuring set2 needs to be reported.

A difference between Opt-1-3 and Opt-1-1 lies in that Opt-1-3 activates/deactivates only specified resource set in specified CSI-ReportConfig, and if Opt-1-1 indicates resource set, CSI Report related to the resource set may be activated/deactivated.

### Example 2: For DCI of a Plurality of UEs in One Cell

Opt-2-1: A plurality of UEs are indicated by different fields, as shown in Table 2-1 below:

TABLE 2-1
Group common DCI

| | | | | |
|---|---|---|---|---|
| UE 1 | UE 2 | UE 3 | UE 4 | UE 5 |

For content indicated by each UE, refer to Example 1 (namely, how each UE indicates activated/deactivated content) and Example 3 (namely, how each UE indicates activated/deactivated content when there are a plurality of serving cells).

For example, when each UE performs indication in the form of Opt-1-2, RRC configures UE 1 to indicate a mapping relationship between Index and CSI-ReportConfigId, NZP-CSI-RS-ResourceSetId in an energy-saving manner, as shown in Table 2-2:

TABLE 2-2

| DCI energy-saving indication | CSI-Re- | NZP-CSI-RS-Re- |
|---|---|---|
| Index value | portConfigId | sourceSetId |
| 0 = ‘00’ | 2 | 1 |
| 1 = ‘01’ | 3 | 2 |
| 2 = ‘10’ | 1 | 16 |
| 3 = ‘11’ | 1 | 64 |

RRC configures UE 2 to indicate a mapping relationship between Index and CSI-ReportConfigId, NZP-CSI-RS-ResourceSetId in an energy-saving manner, as shown in Table 2-3:

TABLE 2-3

| DCI energy-saving indication | CSI-Re- | NZP-CSI-RS-Re- |
|---|---|---|
| Index value | portConfigId | sourceSetId |
| 0 = ‘00’ | 2 | 2 |
| 1 = ‘01’ | 3 | 16 |
| 2 = ‘10’ | 4 | 32 |
| 3 = ‘11’ | 1 | 42 |

RRC configures UE 3 to indicate a mapping relationship between Index and CSI-ReportConfigId, NZP-CSI-RS-ResourceSetId in an energy-saving manner, as shown in Table 2-4:

TABLE 2-4

| DCI energy-saving indication | CSI-Re- | NZP-CSI-RS-Re- |
|---|---|---|
| Index value | portConfigId | sourceSetId |
| 0 = ‘00’ | 2 | 2 |
| 1 = ‘01’ | 2 | 32 |
| 2 = ‘10’ | 3 | 16 |
| 3 = ‘11’ | 1 | 42 |

If indication in group common DCI represents the meaning of activating a relevant configuration, values thereof are shown in Table 2-5 below:

TABLE 2-5
Group common DCI

| DCI | DCI | DCI | DCI | DCI |
|---|---|---|---|---|
| energy- | energy- | energy- | energy- | energy- |
| saving | saving | saving | saving | saving |
| indication | indication | indication | indication | indication |
| Index Field | Index Field | Index Field | Index Field | Index Field |
| for UE 1 | for UE 2 | for UE 3 | for UE 4 | for UE 5 |
| Value = 0 | Value = 2 | Value = 1 | NULL | NULL |

It can be learned from Table 2-5 that DCI represents: if the energy-saving indication received by UE 1 is value-0, the network side device activates a resource set of NZP-CSI-RS-ResourceSetId=1 in CSI-ReportConfigId=2 with reference to Table 2-2 configured by RRC of UE 1, . . . , and the rest is the same. If the energy-saving indication received by UE 2 is value=2, the network side device activates a resource set of NZP-CSI-RS-ResourceSetId=32 in CSI-ReportConfigId=4 with reference to Table 2-3 configured by RRC of UE 2. . . .
Opt-2-2: A plurality of UEs may share a same field:
for example, as shown in Table 2-6 below,

TABLE 2-6
Group common DCI

| Field1 | Field2 | Field3 | Field4 | Field5 |
|---|---|---|---|---|
| CSI-Re- | CSI-Re- | CSI-Re- | CSI-Re- | CSI-Re- |
| portConfigId | portConfigId | portConfigId | portConfigId | portConfigId |
| UE group 0 | UE group 1 | UE group 2 | UE group 3 | UE group 4 |
| UE 1, UE 2 | UE 3, UE 4, | UE 6, UE 7 | UE 8 | UE 9, UE 10 |
| | UE 5 | | | |

Both UE 1 and UE 2 are configured to refer to indication of field1, UE 3, UE 4, and UE 5 are all configured to refer to indication of Field2, . . . , and UEs may also be grouped. As shown in Table 2-6, UE 1 and UE 2 are divided into group0, UEs belonging to group0 refer to Field2, UE 3, UE 4, and UE 5 are divided into group1, and UEs belonging to group1 refer to Field2.

Alternatively, as shown in Table 2-7 and Table 2-10 below,

RRC configures, in advance, UE 1 to indicate a mapping relationship between energy-saving indication Index and CSI-ReportConfigId, NZP-CSI-RS-ResourceSetId in an energy-saving manner, and it is assumed that each UE has two configurations, corresponding to two Indexes, as shown in Table 2-7 below:

TABLE 2-7

| DCI energy-saving indication | CSI-ReportCon- | NZP-CSI-RS-Re- |
|---|---|---|
| Index value | figId | sourceSetId |
| 0 (energy-saving state) | 2 | 1 |
| 1 (non-energy-saving state) | 3 | 2 |

RRC configures UE 2 to indicate a mapping relationship between Index and CSI-ReportConfigId, NZP-CSI-RS-ResourceSetId in an energy-saving manner, as shown in Table 2-8 below:

TABLE 2-8

| DCI energy-saving indication | CSI-ReportCon- | NZP-CSI-RS-Re- |
|---|---|---|
| Index value | figId | sourceSetId |
| 0 (energy-saving state) | 2 | 2 |
| 1 (non-energy-saving state) | 3 | 16 |

RRC configures UE 2 to indicate a mapping relationship between Index and CSI-ReportConfigId, NZP-CSI-RS-ResourceSetId in an energy-saving manner, as shown in Table 2-9 below:

TABLE 2-9

| DCI energy-saving indication | CSI-ReportCon- | NZP-CSI-RS-Re- |
|---|---|---|
| Index value | figId | sourceSetId |
| 0 (energy-saving state) | 2 | 2 |
| 1 (non-energy-saving state) | 2 | 32 |

If group common DCI indication represents the meaning of activation, values thereof are shown in Table 2-10 below:

TABLE 2-10
Group common DCI

| DCI | DCI | DCI | DCI | DCI |
|---|---|---|---|---|
| energy- | energy- | energy- | energy- | energy- |
| saving | saving | saving | saving | saving |
| indication | indication | indication | indication | indication |
| Index Field 1 | Index Field 2 | Index Field 3 | Index Field 4 | Index Field 5 |
| Value = 0 | Value = 2 | Value = 1 | NULL | NULL |

It is assumed that RRC configures UE 1 and UE 2 to refer to Field1, and UE 3 to refer to Field2, the received energy-saving indication Index is value=0 for UE 1. Refer to Table 2-7 configured for UE 1, the network side device activates a resource set of NZP-CSI-RS-ResourceSetId=1 in CSI-ReportConfigId=2, . . . , UE 2 shares a same field with UE 1, and the energy-saving indication Index received by UE 2 is also value=0. Refer to Table 2-8 configured by RRC for UE 2, the network side device activates a resource set of NZP-CSI-RS-ResourceSetId=2 in CSI-ReportConfigId=2. . . .

### Example 3: For DCI of a Plurality of Serving Cells of One UE

Opt-3-1: Explicitly indicate a combination of one or more activated/deactivated CSI report config Id (CSI-ReportConfigId), CSI resource configId (CSI-ResourceConfigId), CSI resource set Id (NZP-CSI-RS-ResourceSetId), CSI-RS resource Id (NZP-CSI-RS-Resource Id) that are configured with servingcell (or activated servingcell).

For example, as shown in Table 3-1 below,

TABLE 3-1

| DCI Fields | | Value |
|---|---|---|
| ServingcellId | deactivate CSI Report ConfigId | 0 |
| | activate CSI Report ConfigId | 1 |
| | deactivate CSI Resource ConfigId | 2 |
| | activate CSI Resource ConfigId | 3 |
| | deactivate CSI Resource setId | 1 |
| | activate CSI Resource setId | 2 |
| ServingcellId | deactivate CSI Report ConfigId | 2 |
| | activate CSI Report ConfigId | 0 |
| | deactivate CSI Resource ConfigId | NULL |
| | activate CSI Resource ConfigId | NULL |
| | deactivate CSI Resource setId | NULL |
| | activate CSI Resource setId | NULL |
| . . . | . . . | . . . |

Note: Only one of deactivate CSI Report ConfigId, activate CSI Report ConfigId, and the like is listed in Table 3-1, and actually, a plurality of them can be indicated at the same time.
Opt-3-2: Indicate DCI energy-saving indication Index, where a mapping relationship between DCI energy-saving indication Index and one or more of CSI report config Id, CSI resource configId, CSI resource set Id, and CSI-RS resource Id in the serving cell is pre-configured by RRC; and
for example, DCI energy-saving indication Index A refers to a mapping between DCI energy-saving indication Index and CSI Report ConfigId to be activated in the serving cell pre-configured by RRC; DCI energy-saving indication Index B refers to a mapping between DCI energy-saving indication Index and CSI Report ConfigId to be deactivated in the serving cell pre-configured by RRC; DCI energy-saving indication Index C refers to a mapping between DCI energy-saving indication Index and CSI Resource ConfigId to be activated in the serving cell pre-configured by RRC; DCI energy-saving indication Index D refers to a mapping between DCI energy-saving indication Index and CSI Resource ConfigId to be deactivated in the serving cell pre-configured by RRC; . . . , and the mapping relationship is pre-configured by RRC. For example, the RRC configuration is shown in Table 3-2 below:

TABLE 3-2

| DCI energy-saving indication Index A | CSI Report ConfigId |
|---|---|
| 0 | 3 |
| 1 | 12 |

Group common DCI is shown in Table 3-3 below:

TABLE 3-3

| DCI Fields | | Value |
|---|---|---|
| ServingcellId = X | DCI energy-saving indication Index A | 0 |
| | DCI energy-saving indication Index B | 1 |
| | DCI energy-saving indication Index C | 2 |
| | DCI energy-saving indication Index D | 3 |
| | DCI energy-saving indication Index E | 1 |
| | DCI energy-saving indication Index F | 2 |
| ServingcellId = Y | DCI energy-saving indication Index G | 2 |
| | DCI energy-saving indication Index H | 0 |
| | DCI energy-saving indication Index I | NULL |
| | DCI energy-saving indication Index J | NULL |
| | DCI energy-saving indication Index K | NULL |
| | DCI energy-saving indication Index L | NULL |
| . . . | . . . | . . . |

If a value of DCI energy-saving indication Index A of UE ServingcellId=X in DCI is ‘0’, the network side device activates a report configuration of CSI Report ConfigId=3 of ServingcellId=X of the UE.

Note: In the foregoing example, different fields, that is, different energy-saving indication indexes, represent different functional meanings, which may represent a CSI-RS configuration to be activated or a CSI-RS configuration to be deactivated. Meanings represented by these indexes may be configured by RRC or pre-specified by a protocol. Certainly, only activated Index is configured, and the rest that is not indicated is deactivated; or only deactivated Index is configured, and the rest that is not indicated remains unchanged and may not be modified.

Table 3-1 and Table 3-3 reserve corresponding bit positions for each serving cell of the UE. In addition, the network side device can also change some configurations of a target cell of the UE as required, as shown in Table 3-4 below:

TABLE 3-4

| DCI Fields | | Value |
|---|---|---|
| TargetCellId | DCI energy-saving indication Index A | 0 |
| | DCI energy-saving indication Index B | 1 |
| | DCI energy-saving indication Index C | 2 |
| | DCI energy-saving indication Index F | 2 |
| TargetCellId | DCI energy-saving indication Index G | 2 |
| | DCI energy-saving indication Index H | 0 |
| . . . | . . . | . . . |

Opt-3-3: Indicate enabled or disabled report config (CSI-ReportConfig)+corresponding resource set (NZP-CSI-RS-ResourceSet) (indicated bits are determined based on a number of configured resource sets);
a number of bits occupied by a field of each serving cell is configured by the network side; and
as shown in Table 3-5 and Table 3-6 below:

TABLE 3-5
Group common DCI fields

| | | |
|---|---|---|
| Serving cell Id | CSI-ReportConfigId | NZP-CSI-RS-ResourceSetId |
| Serving cell Id | CSI-ReportConfigId | NZP-CSI-RS-ResourceSetId |

TABLE 3-6
Group common DCI fields

| | | |
|---|---|---|
| Serving | CSI-ReportConfigId = 0 | NZP-CSI-RS-ResourceSetId = 0 |
| cell Id | | NZP-CSI-RS-ResourceSetId = 4 |
| Serving | CSI-ReportConfigId = 0 | NZP-CSI-RS-ResourceSetId = 3 |
| cell Id | CSI-ReportConfigId = 1 | NZP-CSI-RS-ResourceSetId = 3 |
| Serving | CSI-ReportConfigId = 0 | NZP-CSI-RS-ResourceSetId = 1 |
| cell Id | | NZP-CSI-RS-ResourceSetId = 3 |
| | CSI-ReportConfigId = 1 | NZP-CSI-RS-ResourceSetId = 2 |
| | | NZP-CSI-RS-ResourceSetId = 4 |

### Example 4: For DCI of a Plurality of Serving Cells of a Plurality of UEs

Opt-4-1: Explicitly notify to-be-activated/deactivated CSI report config Id, CSI resource configId, CSI resource set Id, and CSI-RS resource Id of each configured servingcell (or activated servingcell) of each UE. A number of bits occupied by each UE can be the same or different, and are configured by the network side; positionInDCI and payloadsize are configured by RRC; and for content indicated by each UE, refer to Example 3:
for example, as shown in Table 4-1 to Table 4-4 below,

TABLE 4-1

| | DCI Fields | | Value |
|---|---|---|---|
| UE 1 | ServingcellId | deactivate CSI Report ConfigId | 0 |
| | | activate CSI Report ConfigId | 1 |
| | | deactivate CSI Resource ConfigId | 2 |
| | | activate CSI Resource ConfigId | 3 |
| | | deactivate CSI Resource setId | 1 |
| | | activate CSI Resource setId | 2 |
| | ServingcellId | deactivate CSI Report ConfigId | 2 |
| | | activate CSI Report ConfigId | 0 |
| | | deactivate CSI Resource ConfigId | NULL |
| | | activate CSI Resource ConfigId | NULL |
| | | deactivate CSI Resource setId | NULL |
| | | activate CSI Resource setId | NULL |
| UE 2 | ServingcellId | deactivate CSI Report ConfigId | 1 |
| | | activate CSI Report ConfigId | 0 |
| | | deactivate CSI Resource ConfigId | NULL |
| | | activate CSI Resource ConfigId | NULL |
| | | deactivate CSI Resource setId | NULL |
| | | activate CSI Resource setId | NULL |
| | ServingcellId | deactivate CSI Report ConfigId | 2 |
| | | activate CSI Report ConfigId | 0 |
| | | deactivate CSI Resource ConfigId | NULL |
| | | activate CSI Resource ConfigId | NULL |
| | | deactivate CSI Resource setId | NULL |
| | | activate CSI Resource setId | NULL |
| . . . | . . . | . . . | . . . |

TABLE 4-2

| | | | va- |
|---|---|---|---|
| | DCI Fields | | lue |
| UE | ServingcellId | One entry of deactivate CSI Report ConfigList | 0 |
| 1 | | One entry of activate CSI Report ConfigList | 1 |
| | | One entry of deactivate CSI Resource ConfigList | 2 |
| | | One entry of activate CSI Resource ConfigList | 3 |
| | | One entry of deactivate CSI Resource setList | 1 |
| | | One entry of activate CSI Resource setList | 2 |
| | ServingcellId | One entry of deactivate CSI Report ConfigList | 2 |
| | | One entry of activate CSI Report ConfigList | 0 |
| UE | ServingcellId | One entry of deactivate CSI Report ConfigList | 1 |
| 2 | | One entry of activate CSI Report ConfigList | 0 |
| | ServingcellId | One entry of deactivate CSI Report ConfigList | 2 |
| | | One entry of activate CSI Report ConfigList | 0 |
| . . . | | | |

TABLE 4-3

| | Fields | | Value |
|---|---|---|---|
| UE 1 | targetcellId | deactivate CSI Report ConfigId | 0 |
| | | activate CSI Report ConfigId | 1 |
| | | deactivate CSI Resource ConfigId | 2 |
| | | activate CSI Resource ConfigId | 3 |
| | | deactivate CSI Resource setId | 1 |
| | | activate CSI Resource setId | 2 |
| | targetcellId | deactivate CSI Report ConfigId | 2 |
| | | activate CSI Report ConfigId | 0 |
| UE 2 | targetcellId | deactivate CSI Report ConfigId | 1 |
| | | activate CSI Report ConfigId | 0 |
| UE 3 | targetcellId | | |
| . . . | | | |

TABLE 4-4

| | | | Val- |
|---|---|---|---|
| | Fields | | ue |
| UE | tar- | One entry of deactivate CSI Report ConfigList | 0 |
| 1 | getcellId | One entry of activate CSI Report ConfigList | 1 |
| | | One entry of deactivate CSI Resource ConfigList | 2 |
| | | One entry of activate CSI Resource ConfigList | 3 |
| | | One entry of deactivate CSI Resource setList | 1 |
| | | One entry of activate CSI Resource setList | 2 |
| | tar- | One entry of deactivate CSI Report ConfigList | 2 |
| | getcellId | One entry of activate CSI Report ConfigList | 0 |
| UE | tar- | One entry of deactivate CSI Report ConfigList | 1 |
| 2 | getcellId | One entry of activate CSI Report ConfigList | 0 |
| . . . | | | |

Note: In Table 4-1 and Table 4-2 above, there is only one row for deactivate CSI Report Config/activate CSI Report Config, and the like, but a plurality of rows can be configured in actual configuration, that is, a plurality of CSI Report Configs can be activated/deactivated at the same time, and the like. A number of bits of each deactivated/activated CSI report config field of each servingcell of each UE is related to a maximum number of configured CSI report configs. In Table 4-3 and Table 4-4 above, there is only one row for entry of entry/activate CSI Report ConfigList of deactivate CSI Report ConfigList, and the like, but a plurality of rows can be configured in actual configuration, that is, entry of a plurality of CSI Report ConfigLists can be activated/deactivated at the same time, and the like. A number of bits of each deactivated/activated CSI report config field of each targetcell of each UE is related to a maximum number of configured CSI report configs.
Opt-4-2: Indicate DCI energy-saving indication Index, where different DCI energy-saving indication Indexes are mapping between the DCI energy-saving indication Index and one or more of CSI report config, CSI resource config, CSI resource set, and CSI resource, and the mapping relationship is pre-configured by RRC.

For example, as shown in Table 4-5 below,

TABLE 4-5

| | DCI Fields | | Value |
|---|---|---|---|
| UE 1 | ServingcellId | DCI energy-saving indication Index A | 0 |
| | | DCI energy-saving indication Index B | 1 |
| | | DCI energy-saving indication Index C | 2 |
| | | DCI energy-saving indication Index D | 3 |
| | | DCI energy-saving indication Index E | 1 |
| | | DCI energy-saving indication Index F | 2 |
| | ServingcellId | DCI energy-saving indication Index G | 2 |
| | | DCI energy-saving indication Index H | 0 |
| | | DCI energy-saving indication Index I | NULL |
| | | DCI energy-saving indication Index J | NULL |
| | | DCI energy-saving indication Index K | NULL |
| | | DCI energy-saving indication Index L | NULL |
| UE 2 | ServingcellId | DCI energy-saving indication Index M | 0 |
| | | DCI energy-saving indication Index N | 1 |
| | | DCI energy-saving indication Index O | 2 |
| | | DCI energy-saving indication Index P | 3 |
| | | DCI energy-saving indication Index Q | 1 |
| | | DCI energy-saving indication Index R | 2 |
| | ServingcellId | DCI energy-saving indication Index S | 0 |
| | | DCI energy-saving indication Index T | 1 |
| | | DCI energy-saving indication Index U | 2 |
| | | DCI energy-saving indication Index V | 3 |
| | | DCI energy-saving indication Index W | 1 |
| | | DCI energy-saving indication Index X | 2 |
| . . . | . . . | . . . | . . . |

For a plurality of UEs, as shown in Table 4-5 above, each UE can refer to a different Field, but it is also possible for a plurality of UEs to refer to a same Field, such as Opt-2-2.

If DCI does not constrain in advance a serving cell to which the indication information applies, RRC can configure in advance an association relationship between servingcellId and DCI Index.

RRC configures, in advance, UE 1 to indicate a mapping relationship between energy-saving indication Index and CSI-ReportConfigId, NZP-CSI-RS-ResourceSetId in an energy-saving manner, and it is assumed that each UE has two configurations, corresponding to two Indexes, as shown in Table 4-6 below:

TABLE 4-6

| DCI energy-saving | | | NZP-CSI-RS- |
|---|---|---|---|
| indication Index | | CSI-ReportCon- | Re- |
| value | ServingcellId | figId | sourceSetId |
| 0 (energy-saving | 1 | 2 | 1 |
| state) | | | |
| 1 (non-energy-saving | 1 | 3 | 2 |
| state) | | | |

RRC configures UE 2 to indicate a mapping relationship between energy-saving indication Index and CSI-ReportConfigId, NZP-CSI-RS-ResourceSetId in an energy-saving manner, and it is assumed that each UE has two configurations, corresponding to two Indexes, as shown in Table 4-7 below:

TABLE 4-7

| DCI energy-saving | | | NZP-CSI-RS- |
|---|---|---|---|
| indication Index | | CSI-ReportCon- | Re- |
| value | ServingcellId | figId | sourceSetId |
| 0 (energy-saving | 1 | 2 | 2 |
| state) | | | |
| 1 (non-energy-saving | 1 | 3 | 16 |
| state) | | | |

RRC configures UE 3 to indicate a mapping relationship between energy-saving indication Index and CSI-ReportConfigId, NZP-CSI-RS-ResourceSetId in an energy-saving manner, and it is assumed that each UE has two configurations, corresponding to two Indexes, as shown in Table 4-8 below:

TABLE 4-8

| DCI energy-saving | | | NZP-CSI-RS- |
|---|---|---|---|
| indication Index | | CSI-ReportCon- | Re- |
| value | ServingcellId | figId | sourceSetId |
| 0 (energy-saving | 1 | 2 | 2 |
| state) | | | |
| 1 (non-energy-saving | 1 | 2 | 32 |
| state) | | | |

If RRC configures UE 1 and UE 2 to refer to Field1 in DCI, and UE 3 to refer to Field2 in DCI,
group common DCI indication represents the meaning of activation, and values thereof are shown in Table 4-9 below:

TABLE 4-9

| | Group common DCI |
|---|---|
| UE 1, UE 2 | DCI energy-saving indication Index value = 0 |
| UE 3 | DCI energy-saving indication Index value = 1 |

The received energy-saving indication Index is value=0 for UE 1. Refer to Table 4-6 configured for UE 1, the network side device activates a resource set of NZP-CSI-RS-ResourceSetId=1 in CSI-ReportConfigId=2 in ServingcellId=1 of UE 1, . . . , UE 2 shares a same field with UE 1, and the energy-saving indication Index received by UE 2 is also value=0. Refer to Table 4-7 configured by RRC for UE 2, the network side device activates a resource set of NZP-CSI-RS-ResourceSetId=2 in CSI-ReportConfigId=2 in ServingcellId=1 of UE 2. . . .
Opt-4-3: Indicate enabled or disabled report config (CSI-ReportConfig) in serving cell of UE+corresponding resource set (NZP-CSI-RS-ResourceSet) (indicated bits are determined based on a number of configured resource sets); and
as shown in Table 4-10 and Table 4-11 below,

TABLE 4-10

| | Group common DCI fields | | |
|---|---|---|---|
| UE | Serving | CSI-ReportConfigId = 0 | NZP-CSI-RS-ResourceSetId = 0 |
| 1 | cell Id | | NZP-CSI-RS-ResourceSetId = 4 |
| UE | Serving | CSI-ReportConfigId = 0 | NZP-CSI-RS-ResourceSetId = 3 |
| 2 | cell Id | CSI-ReportConfigId = 1 | NZP-CSI-RS-ResourceSetId = 3 |
| | Serving | CSI-ReportConfigId = 0 | NZP-CSI-RS-ResourceSetId = 1 |
| | cell Id | | NZP-CSI-RS-ResourceSetId = 3 |
| | | CSI-ReportConfigId = 1 | NZP-CSI-RS-ResourceSetId = 2 |
| | | | NZP-CSI-RS-ResourceSetId = 4 |

TABLE 4-11

| | Group common DCI fields | | |
|---|---|---|---|
| UE | Target | CSI-ReportConfigId = 0 | NZP-CSI-RS-ResourceSetId = 0 |
| 1 | cell Id | | NZP-CSI-RS-ResourceSetId = 4 |
| UE | Target | CSI-ReportConfigId = 0 | NZP-CSI-RS-ResourceSetId = 3 |
| 2 | cell Id | CSI-ReportConfigId = 1 | NZP-CSI-RS-ResourceSetId = 3 |
| | Target | CSI-ReportConfigId = 0 | NZP-CSI-RS-ResourceSetId = 1 |
| | cell Id | | NZP-CSI-RS-ResourceSetId = 3 |
| | | CSI-ReportConfigId = 1 | NZP-CSI-RS-ResourceSetId = 2 |
| | | | NZP-CSI-RS-ResourceSetId = 4 |

Note 1: If the DCI represents disabling NZP-CSI-RS-ResourceSet, the set indicated by DCI represents being deactivated, and corresponding CSI does not need to be reported, and remaining CSI corresponding to the set that is not deactivated is still reported normally; if the DCI represents enabling NZP-CSI-RS-ResourceSet, it may have two meanings. The first meaning refers to “overwrite”, that is, no matter what the previous configuration is, only a set newly indicated by DCI is activated, and the rest is deactivated; and the second meaning refers to “additional” activation indications on the original configuration, that is, the original configuration remains unchanged, and some sets are newly activated on the original configuration.
Note 2: The annotation in Note 1 takes CSI-RS resource set as an example, but it also applies to indications of CSI-ReportConfig, CSI-ResourceConfig, and CSI-RS Resource group.

In addition, in this embodiment, indication for a change related to CSI reporting configuration of a UE is described as follows:

### Example 5: For a UE

1. RRC configures nzp-CSI-RS-ResourceSetToDeactivateList (new RRC parameter) of an activated serving cell:

$$nzp - CSI - RS - ResourceSetToDeactivateList = ( 0 ; 1 ; 2 ; 3 , 4 ; 4 , 5 , 6 ; ) ;$$

deactivate is used as an example, but nzp-CSI-RS-ResourceSetToactivateList (new RRC parameter) can be configured at the same time, or activate and deactivate are in a same list.
2. An association relationship among CSI-RS report config, CSI-RS resource config Id, and nzp-CSI-RS Resource Set configured by RRC is shown in Table 5-1 below:

TABLE 5-1

| | | |
|---|---|---|
| CSI-RS report | associated CSI-RS resource | nzp-CSI-RS Resource Set 0 |
| config0 | config Id = 0 | |
| CSI-RS report | associated CSI-RS resource | nzp-CSI-RS Resource Set 1 |
| config1 | config Id = 1 | |
| CSI-RS report | associated CSI-RS resource | nzp-CSI-RS Resource Set 2 |
| config2 | config Id = 2 | |
| | associated CSI-RS resource | nzp-CSI-RS Resource Set 3 |
| | config Id = 3 | |
| CSI-RS report | associated CSI-RS resource | nzp-CSI-RS Resource Set 4 |
| config3 | config Id = 4 | nzp-CSI-RS Resource Set 5 |

Namely, associated CSI-RS resource config Id=0 in CSI-RS report config0, and CSI-RS Resource set used for channel measurement in CSI-RS resource config is nzp-CSI-RS Resource Set 0, and the rest is the same.
3. RRC configures an activated serving of DCI apply.

After RRC finishes configuration, DCI indicates entry0 in nzp-CSI-RS-ResourceSetToDeactivateList in activated servingcell of the UE, set0 is deactivated, and correspondingly, CSI-RS report config 0 associated with set0 does not need to be reported;
if DCI indicates entry3 in nzp-CSI-RS-ResourceSetToDeactivateList, set3 and set4 are deactivated, CSI obtained by measuring nzp-CSI-RS Resource Set 3 in CSI-RS report config2 does not need to be reported, and CSI obtained by measuring nzp-CSI-RS Resource Set 4 in CSI-RS report config3 does not need to be reported; and
if DCI indicates entry4 in nzp-CSI-RS-ResourceSetToDeactivateList, set4, set5, and set6 are deactivated, and CSI-RS report config3 does not need to be reported.

### Example 6: For a UE

1. RRC configures CSI-ResourceConfigToDeactivateList (new RRC parameter) of an activated serving cell:

$$CSI - ResourceConfigToDeactivateList = ( 0 ; 1 ; 2 ; 3 , 4 ; 4 , 5 , 6 ; ) ;$$

deactivate is used as an example, but CSI-ResourceConfigToActivateList (new RRC parameter) can be configured at the same time, or activate and deactivate are in a same list.
2. An association relationship among CSI-RS report config and CSI-RS resource config Id configured by RRC is shown in Table 6-1 below:

TABLE 6-1

| | |
|---|---|
| CSI-RS report config0 | associated CSI-RS resource config Id = 0 |
| CSI-RS report config1 | associated CSI-RS resource config Id = 1 |
| CSI-RS report config2 | associated CSI-RS resource config Id = 2 |
| | associated CSI-RS resource config Id = 3 |
| CSI-RS report config3 | associated CSI-RS resource config Id = 4 |

Namely, associated CSI-RS resource config Id=0 in CSI-RS report config0, associated CSI-RS resource config Id=2 and 3 in CSI-RS report config2, and the rest is the same.

After RRC finishes configuration, DCI indicates entry0 in CSI-ResourceConfigToDeactivateList in activated servingcell of the UE, CSI-RS resource config 0 is deactivated, and correspondingly, CSI-RS report config 0 corresponding to CSI-RS resource config 0 does not need to be reported;
if DCI indicates entry3 in CSI-ResourceConfigToDeactivateList, CSI-RS resource config 3 and CSI-RS resource config 4 are deactivated, corresponding CSI in CSI-RS report config 2 corresponding to CSI-RS resource config 3 does not need to be reported, and CSI-RS report config 3 corresponding to CSI-RS resource config 4 does not need to be reported; and
if DCI indicates entry4 in CSI-ResourceConfigToDeactivateList, CSI-RS resource config 4, CSI-RS resource config 5, and CSI-RS resource config 6 are deactivated, and CSI-RS report config3 does not need to be reported.

### Example 7: For a UE

RRC configures the UE to learn that the serving cell has P/SP CSI-Report config 0, CSI-Report config 1, and CSI-Report config 2; and
when DCI indicates CSI-Report config Id=2 of the serving cell to the UE, the UE considers that CSI-Report config 2 is still reported normally, and CSI-Report config0 and CSI-Report config1 are deactivated by default. In this case, CSI-Report config Id in DCI represents CSI-Report config Id to be activated. If DCI indicates CSI-Report config Id=0 and 1 of the serving cell to the UE, the UE considers that CSI-Report config2 is deactivated by default.

CSI-Report config Id indicated in DCI can also represent configuration Id that is about to be deactivated. When DCI indicates CSI-Report config Id=2 of the serving cell to the UE, UE considers that CSI-Report config2 is about to be deactivated, while CSI-Report config 0 and CSI-Report config 1 remain unchanged; and when DCI indicates CSI-Report config Id=1 and 2 of the serving cell to the UE, CSI-Report config 1 and CSI-Report config 2 are deactivated, and the UE considers that CSI report of CSI-Report config Id=0 resumes reporting by default, referring to information that is configured by RRC previously.

In addition, in this embodiment, the second indication information can be a network energy-saving combination identity (NESCombinationId). NESCombination corresponding to NESCombinationId is NESCombination in a network energy-saving configuration (NESConfigPerCell) of each cell included in a configured high-level parameter network energy-saving indicator (NetworkEnergySavingIndicator).

For a UE, RRC configures NetworkEnergySavingIndicator.

| For example, NetworkEnergySavingIndicator ::= | | SEQUENCE { |
|---|---|---|
| NES-RNTI | RNTI-Value, | |
| dci-PayloadSize | INTEGER (1..maxNES-DCI-PayloadSize), | |
| NESConfigToAddModList | | SEQUENCE |
| (SIZE(1..maxNrofAggregatedCellsPerCellGroup)) | OF | NESConfigPerCell |

OPTIONAL, -- Need N

| NESConfigToReleaseList | | SEQUENCE |
|---|---|---|
| (SIZE(1..maxNrofAggregatedCellsPerCellGroup)) | OF | ServCellIndex |

OPTIONAL, -- Need N
...,

The UE can obtain the group common RNTI through NES-RNTI, obtain DCI payload size through dci-PayloadSize, and learns NES configuration information that needs to be configured and released through NESConfigToAddModList and NESConfig ToReleaseList.

For each serving cell in the serving cell set, the UE can be provided with at least one of the following through NESConfigPerCell:
ServingcellId;
a group of NESCombinations; and
a start bit of NESConfigcombinatios of servingcellId in group common DCI.

| | |
|---|---|
| For example, NESConfigPerCell ::= | SEQUENCE { |
| servingCellId | ServCellIndex, |
| NESConfigcombinations | SEQUENCE (SIZE |

(1..maxNrofNESConfigCombinationsPerSet)) OF NESCombination
OPTIONAL, -- Need M

| | |
|---|---|
| positionInDCI | INTEGER(0..maxNES-DCI-PayloadSize-1) |

OPTIONAL, -- Need M
...,

Each NESCombination in NESConfigcombinations further includes one or more of the following:
a NEScombination Id;
a periodic CSI report Id to be activated/deactivated;
a semi-static CSI report Id to be activated/deactivated;
an activated/deactivated resource set Id; and
an activated/deactivated resources group Id.

There are also two configurations of NESCombination, one is specific configuration in RRC.

| | |
|---|---|
| for example, NESCombination::= | SEQUENCE { |
| NESCombinationId | NESCombinationId, |
| ActivativePeriodicReportList | SEQUENCE (SIZE |

(1..maxNumberPeriodicCSI-PerBWP-ForCSI-Report)) OF CSI-ReportConfig

| | |
|---|---|
| ReleasePeriodicReportList | SEQUENCE (SIZE |

(1..maxNumberPeriodicCSI-PerBWP-ForCSI-Report)) OF CSI-ReportConfigId

| | |
|---|---|
| ActivativeSemiPersistentReportList | SEQUENCE |

(SIZE (1..maxNumberSemiPersistentCSI-PerBWP-ForCSI-Report)) OF CSI-ReportConfig

| | |
|---|---|
| ReleaseSemiPersistentReportList | SEQUENCE (SIZE |

(1..maxNumberSemiPersistentCSI-PerBWP-ForCSI-Report)) OF CSI-ReportConfigId

| | |
|---|---|
| ActivativeResourceSetList | SEQUENCE (SIZE (1.. |

maxNrofNZP-CSI-RS-ResourceSets)) OF CSI-RS-ResourceSet

| | |
|---|---|
| ReleaseResourceSetList | SEQUENCE (SIZE |

(1..maxNrofNZP-CSI-RS-ResourceSets)) OF CSI-ResourceSetId

| | |
|---|---|
| ActivativeResourcesgroupList | SEQUENCE (SIZE (1.. |

maxNrofNZP-CSI-RS-ResourcesPerSet)) OF CSI-RS-Resource

| | |
|---|---|
| ReleaseResourcesgroupList | SEQUENCE (SIZE (1.. |

maxNrofNZP-CSI-RS-ResourcesPerSet)) OF CSI-ResourceId
}

The other is to pre-configure the table as shown in Table 7-1 below, and configure it to the UE by indicating the Index therein:

TABLE 7-1

| ConfigCombi- | Activate | | | | | |
|---|---|---|---|---|---|---|
| nation | CSI-Report | CSI-Re- | NZP-CSI-RS- | NZP-CSI-RS- | NZP-CSI-RS-Re- | Deactivate |
| Index | ConfigId | sourceConfigId | ResourceSetId | ResourceId | sourcegroupId | . . . |

| | | | | |
|---|---|---|---|---|
| 0 | 0 | 0 | 0.1 | 0, 1, 2, 3 |
| 1 | 1 | 1 | 0.1 | 0, 1, 2, 3 |
| 2 | 2 | 2 | 2.3 | 0, 1, 2, 3 |
| 3 | 3 | 0.1 | 4.5 | 2, 3, 4, 5, 6 |
| 4 | 0.1 | 2.3 | 4.5 | 4, 5, 6, 7, 8, 9 |
| 5 | 1, 2, 3 | 0, 1, 2 | 5, 6, 7 | 3, 4, 5, 6, 7, 8, |

. . . It is assumed that maximum is 255.

| | |
|---|---|
| NESCombination::= | SEQUENCE { |
| NESCombinationId | NESCombinationId, |
| ConfigCombination | SEQUENCE (SIZE (1..maxNrof ConfigCombination)) |

OF INTEGER (0..255)
}

In this way, if a high-level parameter NetworkEnergySavingIndicator is configured, UE can obtain NESConfig1, NESConfig2, NESConfig3, . . . , and NESConfigN. The network side informs the UE through RRC configuration of monitoring which DCI scrambled by RNTI. The UE obtains NESCombinationId from payload of NES group common DCI (based on position in DCI), and a relevant configuration in NEScombination corresponding to the NESCombinationId will take effect in a next slot of a slot in which the DCI is received.

Optionally, in this embodiment, the network side device pre-configures two sets of parameters for each UE, one set of parameters for the network side device in a normal mode (non-energy-saving state), and the other set of parameters for the network side device in an energy-saving mode (energy-saving state).

For different UEs, the two sets of parameters configured are shown in Table 8-1 to Table 8-4 below:

TABLE 8-1
RRC table for UE 1

| Energy-saving | | CSI- | CSI-Re- | NZP-CSI- | |
|---|---|---|---|---|---|
| indication | BWP | Report | sourceCon- | RS-Re- | power |
| Index | index | ConfigId | figId | sourceSetId | offset |
| 0 | 2 | 1 | 2 | 32 | 1 |
| 1 | 1 | 2 | 10 | 16 | 3 |

TABLE 8-2
RRC table for UE 2

| Energy-saving | | CSI- | CSI-Re- | NZP-CSI- | |
|---|---|---|---|---|---|
| indication | BWP | Report | sourceCon- | RS-Re- | power |
| Index | index | ConfigId | figId | sourceSetId | offset |
| 0 (normal state) | 2 | 1 | 2 | 48 | 1 |
| 1 (energy- | 3 | 2 | 20 | 16 | 3 |
| saving state) | | | | | |

TABLE 8-3
RRC table for UE 3

| Energy-saving | | CSI- | CSI-Re- | NZP-CSI- | |
|---|---|---|---|---|---|
| indication | BWP | Report | sourceCon- | RS-Re- | power |
| Index | index | ConfigId | figId | sourceSetId | offset |
| 0 (normal state) | 1 | 1 | 2 | 16 | 1 |
| 1 (energy- | 3 | 2 | 10 | 48 | 3 |
| saving state) | | | | | |

TABLE 8-4

| | | | | | |
|---|---|---|---|---|---|
| Energy-saving | | CSI- | CSI-Re- | NZP-CSI- | |
| indication | BWP | Report | sourceCon- | RS-Re- | power |
| Index | index | ConfigId | figId | sourceSetId | offset |

RRC table for UE 4

| | | | | | |
|---|---|---|---|---|---|
| 0 (normal state) | 2 | 1 | 2 | 32 | 1 |
| 1 (energy- | 3 | 2 | 10 | 32 | 3 |
| saving state) | | | | | |

RRC table for UE 5

| | | | | | |
|---|---|---|---|---|---|
| 0 (normal state) | 2 | 1 | 2 | 16 | 1 |
| 1 (energy- | 3 | 2 | 10 | 16 | 3 |
| saving state) | | | | | |

In this way, for each UE or UE group, DCI can indicate two sets of parameters corresponding to two states of 0 and 1 respectively by carrying indication information, such as 1 bit energy-saving indication Index. The UE performs implicit handover based on the indication of DCI. Herein, DCI can be realized by adding 1 bit or redefining the existing reserved bit based on the existing group common DCI such as 2_0 or paging DCI.

In this embodiment of this application, example 9:
the network side is configured with a set of CSI-RS Resource with a plurality of ports (for example, 64 ports), and DCI is used to carry muting patternId in the indication information to indicate a plurality of muting patterns to the UE. The plurality of muting patterns can be either 16-port muting patterns or 32-port muting patterns, and the UE reports CSI of the plurality of muting patterns.

In this example, the network side always sends a resource, but the UE reports a variety of CSI of assumption based on different measurement assumptions configured by the network side;
for another example, the network side sends a 64-port CSI-RS. Through this set of CSI-RS, the UE can report 32-port/16-port/8-port CSI; and
for another example, the network side sends a set of CSI-RS, but with two different poweroffsets, the UE can report CSI for these two poweroffsets.

In this embodiment of this application, Example 10: a relationship between an energy-saving indication Index and a resource configuration is configured for UE in advance, as shown in Table 10-1 below:

TABLE 10-1

| Energy-saving | |
|---|---|
| indication Index | |
| 0 | (CMR1, IMR1) |
| 1 | (CMR2, IMR2) |
| 2 | (CMR3, IMR3) |
| 3 | (CMR4, IMR4, resource for MU-MIMO Interference4) |
| 4 | (CMR5, IMR5, resource for MU-MIMO Interference5) |
| 5 | (CMR2, IMR2) |
| | (CMR3, IMR3) |
| 6 | (CMR3, IMR3) |
| | (CMR5, IMR5, resource for MU-MIMO Interference5) |
| 7 | (CMR4, IMR4, resource for MU-MIMO Interference4) |
| | (CMR5, IMR5, resource for MU-MIMO Interference5) |

In this example, the UE can configure a plurality of CMR/IMR/resources for MU-MIMO Interference5 in a reporting configuration, and then activate one or more CMR/IMR/resources for MU-MIMO Interference5 through the indication information, and the UE can report corresponding CSI.

In conclusion, in the channel state information reporting and processing method in this embodiment of this application, a configuration related to CSI reporting or a state related to CSI-RS can be dynamically changed, and a change of the number of ports of the network side device may be adapted; group common DCI carries the indication information to reduce signaling overheads; and it is allowed to activate a plurality of groups of CSI-RS Resource sets (NZP-CSI-RS-ResourceSet) associated with the same report config (CSI-ReportConfig) simultaneously, so that the UE can report multi-CSI simultaneously.

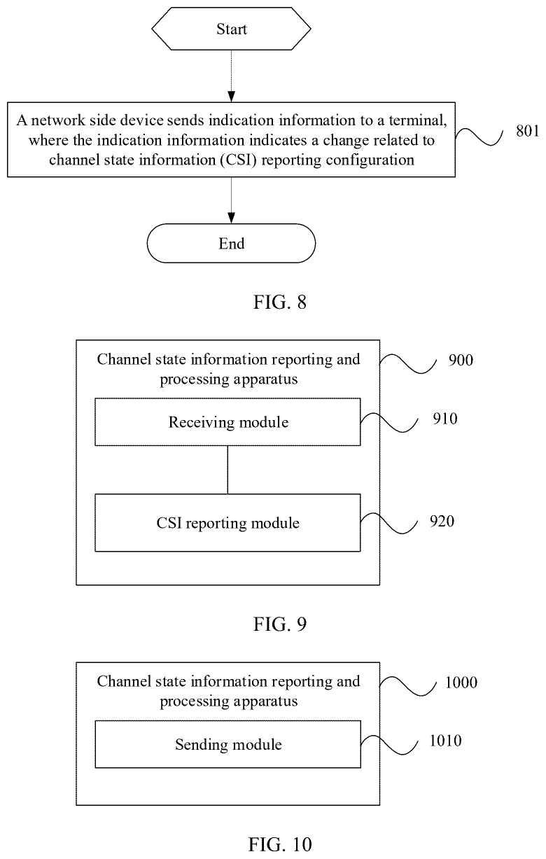

As shown in FIG. 8, a channel state information reporting and processing method according to an embodiment of this application includes the following steps.

Step 801: A network side device sends indication information to a terminal, where the indication information indicates a change related to channel state information (CSI) reporting configuration.

That is, the network side device sends the indication information, so that the terminal learns of the change related to the CSI reporting configuration, to perform CSI reporting based on the indication information, and avoid the problem that the terminal performs invalid CSI measurement, and reported CSI is inaccurate due to the fact that CSI reporting cannot meet a scenario requirement.

Optionally, the indication information is transmitted through at least one of the following signaling:
group common downlink control information (DCI);
broadcast DCI;
multicast DCI; and
a media access control control element (MAC CE).

Optionally, the indication information includes at least one of the following:
a serving cell identity;
a band width part (BWP) identity;
first indication information, where the first indication information indicates to activate or deactivate a first object;
CSI-RS related information;
power offset related information;
second indication information, where the second indication information is in a mapping relationship with the first object;
random access channel (RACH) related information;
an antenna port muting pattern identity;
port related information; and
third indication information, where the third indication information indicates at least one CSI reporting configuration, where
the first object includes at least one of the following:
a serving cell; a BWP; a CSI reporting configuration; a CSI-RS resource set; a CSI-RS resource configuration; a CSI-RS resource; and a CSI-RS resource group.

Optionally, the CSI-RS related information includes at least one of the following:
fourth indication information, where the fourth indication information indicates at least one CSI-RS resource set;
fifth indication information, where the fifth indication information indicates at least one CSI-RS resource configuration;
sixth indication information, where the sixth indication information indicates at least one CSI-RS resource; and
seventh indication information, where the seventh indication information indicates at least one CSI-RS resource group, and the CSI-RS resource group is a subset of a CSI-RS resource set, or the CSI-RS resource group includes a plurality of CSI-RS resource sets.

Optionally, the third indication information includes at least one of the following:
a CSI reporting configuration identity;
CSI reporting configuration list information;
entry information in a CSI reporting configuration list; and
a first bitmap, where the first bitmap includes bits corresponding to different CSI reporting configurations.

Optionally, the fourth indication information includes at least one of the following:
a CSI-RS resource set identity;
CSI-RS resource set list information;
entry information in a CSI-RS resource set list; and
a second bitmap, where the second bitmap includes bits corresponding to different CSI-RS resource sets.

Optionally, the fifth indication information includes at least one of the following:
a CSI-RS resource configuration identity;
CSI-RS resource configuration list information;
entry information in a CSI-RS resource configuration list; and
a third bitmap, where the third bitmap includes bits corresponding to different CSI-RS resource configurations.

Optionally, the sixth indication information includes at least one of the following:
a CSI-RS resource identity;
CSI-RS resource list information;
entry information in a CSI-RS resource list; and
a fourth bitmap, where the fourth bitmap includes bits corresponding to different CSI-RS resources.

Optionally, the seventh indication information includes at least one of the following:
a CSI-RS resource group identity;
CSI-RS resource group list information;
entry information in a CSI-RS resource group list; and
a fifth bitmap, where the fifth bitmap includes bits corresponding to different CSI-RS resource groups.

Optionally, a grouping rule of the CSI-RS resource group is configured by the network side device; or is related to a number or density of ports of a CSI-RS resource included in the CSI-RS resource group.

Optionally, the power offset related information includes: at least one power offset value; or an identity corresponding to at least one power offset value, where
the power offset value is a power offset value between a physical downlink shared channel (PDSCH) and a CSI-RS.

Optionally, the port related information includes at least one of the following: a port configuration identity, a number of ports, and a port switch pattern.

Optionally, the RACH related information includes at least one of the following: a random access channel occasion (RO) configuration; and a mapping relationship between a synchronization signal block (SSB) and an RO.

Optionally, an effective start time of the indication information is one of the following:
a next time unit of a time unit in which the indication information is received;
an available effective moment closest to a moment at which the indication information is received; and
a moment that is a first time interval from a moment at which the indication information is received, where
the available effective moment is a moment with a fixed position in each available effective time window.

Optionally, the method further includes:
sending, by the network side device, monitoring configuration information, where the monitoring configuration information is used for the terminal to receive the indication information.

Optionally, the monitoring configuration information includes at least one of the following:
a group common radio network temporary identity (RNTI) of the indication information;
a payload size of the indication information;
a search space configuration of the indication information; and
a start bit of content to be viewed by the terminal in the indication information.

Optionally, the search space configuration includes at least one of the following:
an offset of a physical downlink control channel (PDCCH) on a monitoring period and a time domain; and
a number of PDCCH candidate resources of different aggregation levels.

Optionally, a sending manner of the indication information includes: sending periodically or sending on demand.

Optionally, an information field of the signaling is used for one or more terminals.

Optionally, the group common DCI is a group common DCI scrambled by a group common RNTI.

Optionally, a period of the available effective time window is the same as a period of the indication information.

It should be noted that this method is implemented in cooperation with the channel state information reporting and processing method executed by the terminal, and the implementation of the embodiment of the channel state information reporting and processing method executed by the terminal is suitable for this method with a same technical effect.

The channel state information reporting and processing method provided in this embodiment of this application may be executed by a channel state information reporting and processing apparatus. In this embodiment of this application, that the channel state information reporting and processing apparatus performs the channel state information reporting and processing method is used as an example to describe the channel state information reporting and processing apparatus provided in this embodiment of this application.

As shown in FIG. 9, a channel state information reporting and processing apparatus 900 according to an embodiment of this application, including:
a receiving module 910, configured to receive indication information sent by a network side device, where the indication information indicates a change related to channel state information (CSI) reporting configuration; and
a CSI reporting module 920, configured to perform CSI reporting based on the indication information.

Optionally, the indication information is transmitted through at least one of the following signaling:
group common downlink control information (DCI);
broadcast DCI;
multicast DCI; and
a media access control control element (MAC CE).

Optionally, the indication information includes at least one of the following:
a serving cell identity;
a band width part (BWP) identity;
first indication information, where the first indication information indicates to activate or deactivate a first object;
CSI-RS related information;
power offset related information;
second indication information, where the second indication information is in a mapping relationship with the first object;
random access channel (RACH) related information;
an antenna port muting pattern identity;
port related information; and
third indication information, where the third indication information indicates at least one CSI reporting configuration, where
the first object includes at least one of the following:
a serving cell; a BWP; a CSI reporting configuration; a CSI-RS resource set; a CSI-RS resource configuration; a CSI-RS resource; and a CSI-RS resource group.

Optionally, the CSI-RS related information includes at least one of the following:
fourth indication information, where the fourth indication information indicates at least one CSI-RS resource set;
fifth indication information, where the fifth indication information indicates at least one CSI-RS resource configuration;
sixth indication information, where the sixth indication information indicates at least one CSI-RS resource; and
seventh indication information, where the seventh indication information indicates at least one CSI-RS resource group, and the CSI-RS resource group is a subset of a CSI-RS resource set, or the CSI-RS resource group includes a plurality of CSI-RS resource sets.

Optionally, the third indication information includes at least one of the following:
a CSI reporting configuration identity;
CSI reporting configuration list information;
entry information in a CSI reporting configuration list; and
a first bitmap, where the first bitmap includes bits corresponding to different CSI reporting configurations.

Optionally, the fourth indication information includes at least one of the following:
a CSI-RS resource set identity;
CSI-RS resource set list information;
entry information in a CSI-RS resource set list; and
a second bitmap, where the second bitmap includes bits corresponding to different CSI-RS resource sets.

Optionally, the fifth indication information includes at least one of the following:
a CSI-RS resource configuration identity;
CSI-RS resource configuration list information;
entry information in a CSI-RS resource configuration list; and
a third bitmap, where the third bitmap includes bits corresponding to different CSI-RS resource configurations.

Optionally, the sixth indication information includes at least one of the following:
a CSI-RS resource identity;
CSI-RS resource list information;
entry information in a CSI-RS resource list; and
a fourth bitmap, where the fourth bitmap includes bits corresponding to different CSI-RS resources.

Optionally, the seventh indication information includes at least one of the following:
a CSI-RS resource group identity;
CSI-RS resource group list information;
entry information in a CSI-RS resource group list; and
a fifth bitmap, where the fifth bitmap includes bits corresponding to different CSI-RS resource groups.

Optionally, a grouping rule of the CSI-RS resource group is configured by the network side device; or is related to a number or density of ports of a CSI-RS resource included in the CSI-RS resource group.

Optionally, the power offset related information includes: at least one power offset value; or an identity corresponding to at least one power offset value, where
the power offset value is a power offset value between a physical downlink shared channel (PDSCH) and a CSI-RS.

Optionally, the port related information includes at least one of the following: a port configuration identity, a number of ports, and a port switch pattern.

Optionally, the RACH related information includes at least one of the following: a random access channel occasion (RO) configuration; and a mapping relationship between a synchronization signal block (SSB) and an RO.

Optionally, an effective start time of the indication information is one of the following:
a next time unit of a time unit in which the indication information is received;
an available effective moment closest to a moment at which the indication information is received; and
a moment that is a first time interval from a moment at which the indication information is received, where
the available effective moment is a moment with a fixed position in each available effective time window.

Optionally, the apparatus further includes:
a monitoring configuration receiving module, configured to receive monitoring configuration information sent by the network side device;
the receiving module is further configured to:
receive the indication information based on the monitoring configuration information.

Optionally, the monitoring configuration information includes at least one of the following:
a group common radio network temporary identity (RNTI) of the indication information;
a payload size of the indication information;
a search space configuration of the indication information; and
a start bit of content to be viewed by the terminal in the indication information.

Optionally, the search space configuration includes at least one of the following:
an offset of a physical downlink control channel (PDCCH) on a monitoring period and a time domain; and
a number of PDCCH candidate resources of different aggregation levels.

Optionally, a sending manner of the indication information includes: sending periodically or sending on demand.

Optionally, the apparatus further includes:
a processing module, configured to: in a case that the indication information is not received within a second time interval, perform one of the following:
performing CSI reporting based on latest received indication information; and
performing CSI reporting based on a default configuration.

Optionally, the CSI reporting module is further configured to:
in a case that the indication information indicates to activate or deactivate at least one CSI reporting configuration, report or stop reporting CSI based on a first CSI reporting configuration, where
the first CSI reporting configuration is at least one CSI reporting configuration that the indication information indicates to activate or deactivate.

Optionally, the CSI reporting module is further configured to:
in a case that the indication information indicates to activate or deactivate at least one CSI-RS resource configuration,
report or stop reporting CSI based on a second CSI reporting configuration; or
report or stop reporting CSI based on a first CSI-RS resource configuration, where
the second CSI reporting configuration is a CSI reporting configuration corresponding to the first CSI-RS resource configuration; and the first CSI resource configuration is at least one CSI-RS resource configuration that the indication information indicates to activate or deactivate.

Optionally, the CSI reporting module is further configured to:
in a case that the indication information indicates to activate or deactivate at least one CSI-RS resource set,
report or stop reporting CSI based on a third CSI reporting configuration; or
report or stop reporting CSI based on a second CSI-RS resource configuration; or
report or stop reporting CSI based on a first CSI-RS resource set, where
the third CSI reporting configuration is a CSI reporting configuration corresponding to the second CSI-RS resource configuration, the second CSI-RS resource configuration is a CSI-RS resource configuration corresponding to the first CSI-RS resource set, and the first CSI-RS resource set is at least one CSI-RS resource set that the indication information indicates to activate or deactivate.

Optionally, the CSI reporting module is further configured to:
in a case that the indication information indicates to activate or deactivate at least one CSI-RS resource,
report or stop reporting CSI based on a fourth CSI reporting configuration; or
report or stop reporting CSI based on a third CSI-RS resource configuration; or
report or stop reporting CSI based on a second CSI-RS resource set; or
report or stop reporting CSI based on a first CSI-RS resource, where
the fourth CSI reporting configuration is a CSI reporting configuration corresponding to the third CSI-RS resource configuration, the third CSI-RS resource configuration is a CSI-RS resource configuration corresponding to the second CSI-RS resource set, the second CSI-RS resource set is a resource set to which the first CSI-RS resource belongs, and the first CSI-RS resource is at least one CSI-RS resource that the indication information indicates to activate or deactivate.

Optionally, the CSI reporting module is further configured to:
in a case of reporting or stopping reporting CSI based on a fourth CSI-RS resource configuration, report or stop reporting CSI based on a state of the fourth CSI-RS resource configuration, where the fourth CSI-RS resource configuration is at least one of the following: a first type of CSI-RS resource configuration, a second type of CSI-RS resource configuration, and a third type of CSI-RS resource configuration; or
in a case of reporting or stopping reporting CSI based on a third CSI-RS resource set, report or stop reporting CSI based on a state of the third CSI-RS resource set, where a CSI-RS resource configuration to which the third CSI-RS resource set belongs is at least one of the following: a first type of CSI-RS resource configuration, a second type of CSI-RS resource configuration, and a third type of CSI-RS resource configuration, where
the first type of CSI-RS resource configuration is used for channel measurement; the second type of CSI-RS resource configuration is used for CSI interference measurement; and the third type of CSI-RS resource configuration is used for interference measurement in an MU-MIMO scenario.

Optionally, an information field of the signaling is used for one or more terminals.

Optionally, the group common DCI is a group common DCI scrambled by a group common RNTI.

Optionally, a period of the available effective time window is the same as a period of the indication information.

The apparatus can learn of, by receiving the indication information sent by the network side device, the change related to the CSI reporting configuration, to perform CSI reporting based on the indication information, and avoid the problem that the terminal performs invalid CSI measurement, and reported CSI is inaccurate due to the fact that CSI reporting cannot meet a scenario requirement.

The channel state information reporting and processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in this embodiment of this application.

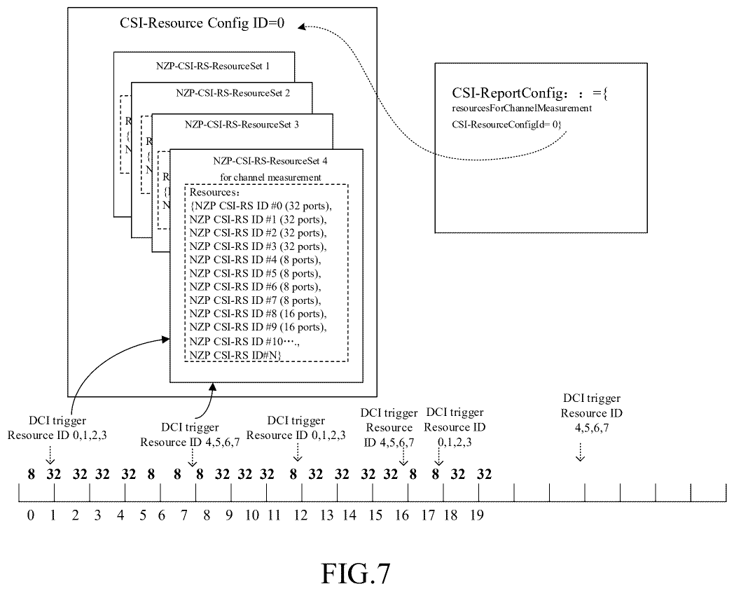

The channel state information reporting and processing apparatus provided in this embodiment of this application can implement the processes implemented in the method embodiment from FIG. 2 to FIG. 7, and a same technical effect can be achieved. To avoid repetition, details are not described herein again.

As shown in FIG. 10, a channel state information reporting and processing apparatus 1000 according to an embodiment of this application, including:
a sending module 1010, configured to send indication information to a terminal, where the indication information indicates a change related to channel state information (CSI) reporting configuration.

Optionally, the indication information is transmitted through at least one of the following signaling:
group common downlink control information (DCI);
broadcast DCI;
multicast DCI; and
a media access control control element (MAC CE).

Optionally, the indication information includes at least one of the following:
a serving cell identity;
a band width part (BWP) identity;
first indication information, where the first indication information indicates to activate or deactivate a first object;
CSI-RS related information;
power offset related information;
second indication information, where the second indication information is in a mapping relationship with the first object;
random access channel (RACH) related information;
an antenna port muting pattern identity;
port related information; and
third indication information, where the third indication information indicates at least one CSI reporting configuration, where
the first object includes at least one of the following:
a serving cell; a BWP; a CSI reporting configuration; a CSI-RS resource set; a CSI-RS resource configuration; a CSI-RS resource; and a CSI-RS resource group.

Optionally, the CSI-RS related information includes at least one of the following:
third indication information, where the third indication information indicates at least one CSI reporting configuration;
fourth indication information, where the fourth indication information indicates at least one CSI-RS resource set;
fifth indication information, where the fifth indication information indicates at least one CSI-RS resource configuration;
sixth indication information, where the sixth indication information indicates at least one CSI-RS resource; and
seventh indication information, where the seventh indication information indicates at least one CSI-RS resource group, and the CSI-RS resource group is a subset of a CSI-RS resource set, or the CSI-RS resource group includes a plurality of CSI-RS resource sets.

Optionally, the third indication information includes at least one of the following:
a CSI reporting configuration identity;
CSI reporting configuration list information;
entry information in a CSI reporting configuration list; and
a first bitmap, where the first bitmap includes bits corresponding to different CSI reporting configurations.

Optionally, the fourth indication information includes at least one of the following:
a CSI-RS resource set identity;
CSI-RS resource set list information;
entry information in a CSI-RS resource set list; and
a second bitmap, where the second bitmap includes bits corresponding to different CSI-RS resource sets.

Optionally, the fifth indication information includes at least one of the following:
a CSI-RS resource configuration identity;
CSI-RS resource configuration list information;
entry information in a CSI-RS resource configuration list; and
a third bitmap, where the third bitmap includes bits corresponding to different CSI-RS resource configurations.

Optionally, the sixth indication information includes at least one of the following:
a CSI-RS resource identity;
CSI-RS resource list information;
entry information in a CSI-RS resource list; and
a fourth bitmap, where the fourth bitmap includes bits corresponding to different CSI-RS resources.

Optionally, the seventh indication information includes at least one of the following:
a CSI-RS resource group identity;
CSI-RS resource group list information;
entry information in a CSI-RS resource group list; and
a fifth bitmap, where the fifth bitmap includes bits corresponding to different CSI-RS resource groups.

Optionally, a grouping rule of the CSI-RS resource group is configured by the network side device; or is related to a number or density of ports of a CSI-RS resource included in the CSI-RS resource group.

Optionally, the power offset related information includes: at least one power offset value; or an identity corresponding to at least one power offset value, where the power offset value is a power offset value between a physical downlink shared channel (PDSCH) and a CSI-RS.

Optionally, the port related information includes at least one of the following: a port configuration identity, a number of ports, and a port switch pattern.

Optionally, the RACH related information includes at least one of the following: a random access channel occasion (RO) configuration; and a mapping relationship between a synchronization signal block (SSB) and an RO.

Optionally, an effective start time of the indication information is one of the following:
a next time unit of a time unit in which the indication information is received;
an available effective moment closest to a moment at which the indication information is received; and
a moment that is a first time interval from a moment at which the indication information is received, where
the available effective moment is a moment with a fixed position in each available effective time window.

Optionally, the apparatus further includes:
a monitoring configuration sending module, configured to send monitoring configuration information, where the monitoring configuration information is used for the terminal to receive the indication information.

Optionally, the monitoring configuration information includes at least one of the following:
a group common radio network temporary identity (RNTI) of the indication information;
a payload size of the indication information;
a search space configuration of the indication information; and
a start bit of content to be viewed by the terminal in the indication information.

Optionally, the search space configuration includes at least one of the following:
an offset of a physical downlink control channel (PDCCH) on a monitoring period and a time domain; and a number of PDCCH candidate resources of different aggregation levels.

Optionally, a sending manner of the indication information includes: sending periodically or sending on demand.

Optionally, an information field of the signaling is used for one or more terminals.

Optionally, the group common DCI is a group common DCI scrambled by a group common RNTI.

Optionally, a period of the available effective time window is the same as a period of the indication information.

The apparatus sends the indication information, so that the terminal learns of the change related to the CSI reporting configuration, to perform CSI reporting based on the indication information, and avoid the problem that the terminal performs invalid CSI measurement, and reported CSI is inaccurate due to the fact that CSI reporting cannot meet a scenario requirement.

The channel state information reporting and processing apparatus in this embodiment of this application may be an electronic device, and the electronic device may be a network side device, or another device other than the network side device. For example, the network side device may include but is not limited to the types of network side devices 12 listed above. This is not specifically limited in this embodiment of this application.

The channel state information reporting and processing apparatus provided in this embodiment of this application can implement the processes implemented in the method embodiment in FIG. 8, and a same technical effect can be achieved. To avoid repetition, details are not described herein again.

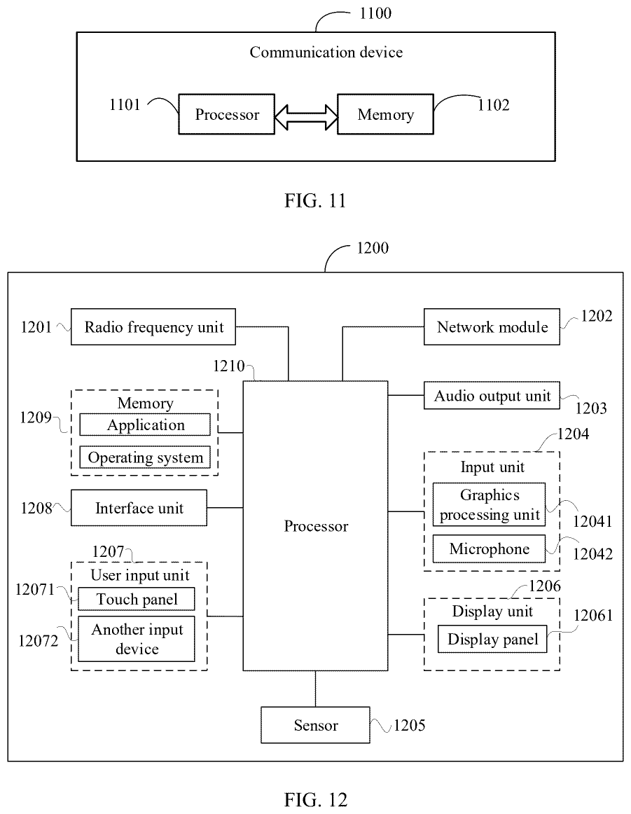

Optionally, as shown in FIG. 11, an embodiment of this application further provides a communication device 1100, including a processor 1101 and a memory 1102. The memory 1102 stores a program or an instruction that can be run on the processor 1101. For example, when the communication device 1100 is a terminal, the program or the instruction is executed by the processor 1101 to implement the steps of the embodiment of the channel state information reporting and processing method, and a same technical effect can be achieved. In a case that the communication device 1100 is a network side device, when the program or the instruction is executed by the processor 1101, the steps of the embodiment of the channel state information reporting and processing method are implemented, and a same technical effect can be achieved. To avoid repetition, details are not described herein again.

An embodiment of this application further provides a terminal, including a processor and a communication interface, where the communication interface is configured to: receive indication information sent by a network side device, and the indication information indicates a change related to channel state information (CSI) reporting configuration; and perform CSI reporting based on the indication information. The terminal embodiment is corresponding to the method embodiment on the terminal side, each implementation process and implementation of the method embodiment can be applied to the terminal embodiment, and a same technical effect can be achieved. Specifically, FIG. 12 is a schematic diagram of a hardware structure of a terminal according to an embodiment of this application.

The terminal 1200 includes but is not limited to at least a part of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art can understand that the terminal 1200 may further include a power supply (such as a battery) that supplies power to each component. The power supply may be logically connected to the processor 1210 by using a power supply management system, to implement functions such as charging and discharging management, and power consumption management by using the power supply management system. The terminal structure shown in FIG. 12 constitutes no limitation on the terminal, and the terminal may include more or fewer components than those shown in the figure, or combine some components, or have different component arrangements. Details are not described herein again.

It should be understood that in this embodiment of this application, the input unit 1204 may include a Graphics Processing Unit (GPU) 12041 and a microphone 12042. The graphics processing unit 12041 processes image data of a static picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein again.

In this embodiment of this application, after receiving downlink data from a network side device, the radio frequency unit 1201 may transmit the downlink data to the processor 1210 for processing. In addition, the radio frequency unit 1201 may send uplink data to the network side device. Generally, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may be a volatile memory or a non-volatile memory, or the memory 1209 may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1209 in this embodiment of this application includes but is not limited to these memories and any memory of another proper type.

The processor 1210 may include one or more processing units. Optionally, an application processor and a modem processor are integrated into the processor 1210. The application processor mainly processes operations involving an operating system, a user interface, an application, or the like. The modem processor mainly processes a wireless communication signal, for example, a baseband processor. It may be understood that, alternatively, the modem processor may not be integrated into the processor 1210.

The radio frequency unit 1201 is configured to: receive indication information sent by a network side device, where the indication information indicates a change related to channel state information (CSI) reporting configuration; and
perform CSI reporting based on the indication information.

The terminal can learn of, by receiving the indication information sent by the network side device, the change related to the CSI reporting configuration, to perform CSI reporting based on the indication information, and avoid the problem that the terminal performs invalid CSI measurement, and reported CSI is inaccurate due to the fact that CSI reporting cannot meet a scenario requirement.

Optionally, the indication information is transmitted through at least one of the following signaling:
group common downlink control information (DCI);
broadcast DCI;
multicast DCI; and
a media access control control element (MAC CE).

Optionally, the indication information includes at least one of the following:
a serving cell identity;
a band width part (BWP) identity;
first indication information, where the first indication information indicates to activate or deactivate a first object;
CSI-RS related information;
power offset related information;
second indication information, where the second indication information is in a mapping relationship with the first object;
random access channel (RACH) related information;
an antenna port muting pattern identity;
port related information; and
third indication information, where the third indication information indicates at least one CSI reporting configuration, where
the first object includes at least one of the following:
a serving cell; a BWP; a CSI reporting configuration; a CSI-RS resource set; a CSI-RS resource configuration; a CSI-RS resource; and a CSI-RS resource group.

Optionally, the CSI-RS related information includes at least one of the following:
fourth indication information, where the fourth indication information indicates at least one CSI-RS resource set;
fifth indication information, where the fifth indication information indicates at least one CSI-RS resource configuration;
sixth indication information, where the sixth indication information indicates at least one CSI-RS resource; and
seventh indication information, where the seventh indication information indicates at least one CSI-RS resource group, and the CSI-RS resource group is a subset of a CSI-RS resource set, or the CSI-RS resource group includes a plurality of CSI-RS resource sets.

Optionally, the third indication information includes at least one of the following:
a CSI reporting configuration identity;
CSI reporting configuration list information;
entry information in a CSI reporting configuration list; and
a first bitmap, where the first bitmap includes bits corresponding to different CSI reporting configurations.

Optionally, the fourth indication information includes at least one of the following:
a CSI-RS resource set identity;
CSI-RS resource set list information;
entry information in a CSI-RS resource set list; and
a second bitmap, where the second bitmap includes bits corresponding to different CSI-RS resource sets.

Optionally, the fifth indication information includes at least one of the following:
a CSI-RS resource configuration identity;
CSI-RS resource configuration list information;
entry information in a CSI-RS resource configuration list; and
a third bitmap, where the third bitmap includes bits corresponding to different CSI-RS resource configurations.

Optionally, the sixth indication information includes at least one of the following:
a CSI-RS resource identity;
CSI-RS resource list information;
entry information in a CSI-RS resource list; and
a fourth bitmap, where the fourth bitmap includes bits corresponding to different CSI-RS resources.

Optionally, the seventh indication information includes at least one of the following:
a CSI-RS resource group identity;
CSI-RS resource group list information;
entry information in a CSI-RS resource group list; and
a fifth bitmap, where the fifth bitmap includes bits corresponding to different CSI-RS resource groups.

Optionally, a grouping rule of the CSI-RS resource group is configured by the network side device; or is related to a number or density of ports of a CSI-RS resource included in the CSI-RS resource group.

Optionally, the power offset related information includes: at least one power offset value; or an identity corresponding to at least one power offset value, where
the power offset value is a power offset value between a physical downlink shared channel (PDSCH) and a CSI-RS.

Optionally, the port related information includes at least one of the following: a port configuration identity, a number of ports, and a port switch pattern.

Optionally, the RACH related information includes at least one of the following: a random access channel occasion (RO) configuration; and a mapping relationship between a synchronization signal block (SSB) and an RO.

Optionally, an effective start time of the indication information is one of the following:
a next time unit of a time unit in which the indication information is received;
an available effective moment closest to a moment at which the indication information is received; and
a moment that is a first time interval from a moment at which the indication information is received, where
the available effective moment is a moment with a fixed position in each available effective time window.

Optionally, the radio frequency unit 1201 is further configured to:
receive monitoring configuration information sent by the network side device; and
receive the indication information based on the monitoring configuration information.

Optionally, the monitoring configuration information includes at least one of the following:
a group common radio network temporary identity (RNTI) of the indication information;
a payload size of the indication information;
a search space configuration of the indication information; and
a start bit of content to be viewed by the terminal in the indication information.

Optionally, the search space configuration includes at least one of the following:
an offset of a physical downlink control channel (PDCCH) on a monitoring period and a time domain; and
a number of PDCCH candidate resources of different aggregation levels.

Optionally, a sending manner of the indication information includes: sending periodically or sending on demand.

Optionally, the processor 1210 is configured to: in a case that the indication information is not received within a second time interval, perform one of the following:
performing CSI reporting based on latest received indication information; and
performing CSI reporting based on a default configuration.

Optionally, the radio frequency unit 1201 is further configured to:
in a case that the indication information indicates to activate or deactivate at least one CSI reporting configuration, report or stop reporting CSI based on a first CSI reporting configuration, where
the first CSI reporting configuration is at least one CSI reporting configuration that the indication information indicates to activate or deactivate.

Optionally, the radio frequency unit 1201 is further configured to:
in a case that the indication information indicates to activate or deactivate at least one CSI-RS resource configuration,
report or stop reporting CSI based on a second CSI reporting configuration; or
report or stop reporting CSI based on a first CSI-RS resource configuration, where
the second CSI reporting configuration is a CSI reporting configuration corresponding to the first CSI-RS resource configuration; and the first CSI resource configuration is at least one CSI-RS resource configuration that the indication information indicates to activate or deactivate.

Optionally, the radio frequency unit 1201 is further configured to:
in a case that the indication information indicates to activate or deactivate at least one CSI-RS resource set,
report or stop reporting CSI based on a third CSI reporting configuration; or
report or stop reporting CSI based on a second CSI-RS resource configuration; or
report or stop reporting CSI based on a first CSI-RS resource set, where
the third CSI reporting configuration is a CSI reporting configuration corresponding to the second CSI-RS resource configuration, the second CSI-RS resource configuration is a CSI-RS resource configuration corresponding to the first CSI-RS resource set, and the first CSI-RS resource set is at least one CSI-RS resource set that the indication information indicates to activate or deactivate.

Optionally, the radio frequency unit 1201 is further configured to:
in a case that the indication information indicates to activate or deactivate at least one CSI-RS resource,
report or stop reporting CSI based on a fourth CSI reporting configuration; or
report or stop reporting CSI based on a third CSI-RS resource configuration; or
report or stop reporting CSI based on a second CSI-RS resource set; or
report or stop reporting CSI based on a first CSI-RS resource, where
the fourth CSI reporting configuration is a CSI reporting configuration corresponding to the third CSI-RS resource configuration, the third CSI-RS resource configuration is a CSI-RS resource configuration corresponding to the second CSI-RS resource set, the second CSI-RS resource set is a resource set to which the first CSI-RS resource belongs, and the first CSI-RS resource is at least one CSI-RS resource that the indication information indicates to activate or deactivate.

Optionally, the radio frequency unit 1201 is further configured to:
in a case of reporting or stopping reporting CSI based on a fourth CSI-RS resource configuration, report or stop reporting CSI based on a state of the fourth CSI-RS resource configuration, where the fourth CSI-RS resource configuration is at least one of the following: a first type of CSI-RS resource configuration, a second type of CSI-RS resource configuration, and a third type of CSI-RS resource configuration; or
in a case of reporting or stopping reporting CSI based on a third CSI-RS resource set, report or stop reporting CSI based on a state of the third CSI-RS resource set, where a CSI-RS resource configuration to which the third CSI-RS resource set belongs is at least one of the following: a first type of CSI-RS resource configuration, a second type of CSI-RS resource configuration, and a third type of CSI-RS resource configuration, where
the first type of CSI-RS resource configuration is used for channel measurement; the second type of CSI-RS resource configuration is used for CSI interference measurement; and the third type of CSI-RS resource configuration is used for interference measurement in an MU-MIMO scenario.

Optionally, an information field of the signaling is used for one or more terminals.

Optionally, the group common DCI is a group common DCI scrambled by a group common RNTI.

Optionally, a period of the available effective time window is the same as a period of the indication information.

An embodiment of this application further provides a network side device, including a processor and a communication interface. The communication interface is configured to send indication information to a terminal, and the indication information indicates a change related to channel state information (CSI) reporting configuration. This network side device embodiment is corresponding to the foregoing method embodiment of the network side device. Each implementation process and implementation of the foregoing method embodiment may be applicable to this network side device embodiment, and a same technical effect can be achieved.

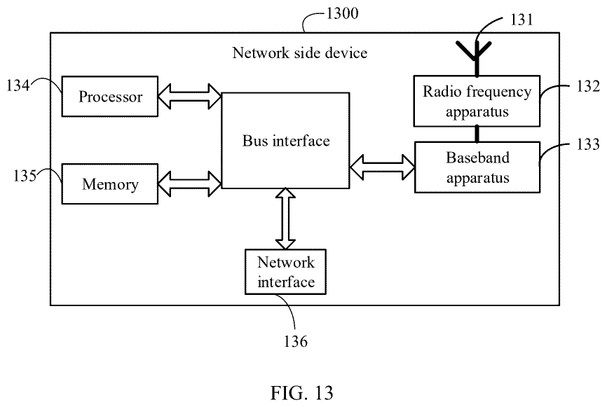

Specifically, an embodiment of this application further provides a network side device. As shown in FIG. 13, the network side device 1300 includes an antenna 131, a radio frequency apparatus 132, a baseband apparatus 133, a processor 134, and a memory 135. The antenna 131 is connected to the radio frequency apparatus 132. In an uplink direction, the radio frequency apparatus 132 receives information through the antenna 131, and sends the received information to the baseband apparatus 133 for processing. In a downlink direction, the baseband apparatus 133 processes information that needs to be sent, and sends processed information to the radio frequency apparatus 132. The radio frequency apparatus 132 processes the received information, and sends processed information through the antenna 131.

In the foregoing embodiment, the method performed by the network side device may be implemented in the baseband apparatus 133. The baseband apparatus 133 includes a baseband processor.

For example, the baseband apparatus 133 may include at least one baseband board. A plurality of chips are disposed on the baseband board. As shown in FIG. 13, one chip is, for example, a baseband processor, and is connected to the memory 135 by using a bus interface, to invoke a program in the memory 135 to perform the operations of the network device shown in the foregoing method embodiment.

The network side device may further include a network interface 136, and the interface is, for example, a common public radio interface (common public radio interface, CPRI).

Specifically, the network side device 1300 in this embodiment of this application further includes an instruction or a program that is stored in the memory 135 and that can be run on the processor 134. The processor 134 invokes the instruction or the program in the memory 135 to perform the method performed by the modules shown in FIG. 10, and a same technical effect is achieved. To avoid repetition, details are not described herein again.

An embodiment of this application further provides a readable storage medium. A program or an instruction is stored in the readable storage medium. When the program or the instruction is executed by a processor, the processes of the embodiment of the channel state information reporting and processing method can be implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the embodiment of the channel state information reporting and processing method, and a same technical effect can be achieved. To avoid repetition, details are not described herein again.

It should be understood that the chip mentioned in this embodiment of this application may also be referred to as a system-level chip, a system chip, a chip system, an on-chip system chip, or the like.

An embodiment of this application further provides a computer program/program product. The computer program/program product is stored in a storage medium, and the computer program/program product is executed by at least one processor to implement the processes of the embodiment of the channel state information reporting and processing method, and a same technical effect can be achieved. To avoid repetition, details are not described herein again.

An embodiment of this application further provides a channel state information reporting and processing system, including a terminal and a network side device, where the terminal may be configured to perform the steps of the channel state information reporting and processing method performed by the terminal, and the network side device may be configured to perform the steps of the channel state information reporting and processing method performed by the network side device.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a more desired implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A channel state information reporting and processing method, comprising:
receiving, by a terminal, indication information sent by a network side device, wherein the indication information indicates a change related to channel state information (CSI) reporting configuration; and
performing, by the terminal, CSI reporting based on the indication information.

2. The method according to claim 1, wherein the indication information comprises at least one of the following:
a serving cell identity;
a band width part (BWP) identity;
first indication information, wherein the first indication information indicates to activate or deactivate a first object;
CSI-RS related information;
power offset related information;
second indication information, wherein the second indication information is in a mapping relationship with the first object;
random access channel (RACH) related information;
an antenna port muting pattern identity;
port related information; and
third indication information, wherein the third indication information indicates at least one CSI reporting configuration, wherein
the first object comprises at least one of the following:
a serving cell; a BWP; a CSI reporting configuration; a CSI-RS resource set; a CSI-RS resource configuration; a CSI-RS resource; and a CSI-RS resource group.

3. The method according to claim 2, wherein the CSI-RS related information comprises at least one of the following:
fourth indication information, wherein the fourth indication information indicates at least one CSI-RS resource set;
fifth indication information, wherein the fifth indication information indicates at least one CSI-RS resource configuration;
sixth indication information, wherein the sixth indication information indicates at least one CSI-RS resource; and
seventh indication information, wherein the seventh indication information indicates at least one CSI-RS resource group, and the CSI-RS resource group is a subset of a CSI-RS resource set, or the CSI-RS resource group comprises a plurality of CSI-RS resource sets.

4. The method according to claim 2, wherein the third indication information comprises at least one of the following:
a CSI reporting configuration identity;
CSI reporting configuration list information;
entry information in a CSI reporting configuration list; and
a first bitmap, wherein the first bitmap comprises bits corresponding to different CSI reporting configurations.

5. The method according to claim 3, wherein the seventh indication information comprises at least one of the following:
a CSI-RS resource group identity;
CSI-RS resource group list information;
entry information in a CSI-RS resource group list; and
a fifth bitmap, wherein the fifth bitmap comprises bits corresponding to different CSI-RS resource groups.

6. The method according to claim 5, wherein a grouping rule of the CSI-RS resource group is configured by the network side device; or is related to a number or density of ports of a CSI-RS resource comprised in the CSI-RS resource group.

7. The method according to claim 2, wherein the power offset related information comprises: at least one power offset value; or an identity corresponding to at least one power offset value, wherein
the power offset value is a power offset value between a physical downlink shared channel (PDSCH) and a CSI-RS.

8. The method according to claim 2, wherein the port related information comprises at least one of the following: a port configuration identity, a number of ports, and a port switch pattern.

9. The method according to claim 1, wherein an effective start time of the indication information is one of the following:
a next time unit of a time unit in which the indication information is received;
an available effective moment closest to a moment at which the indication information is received; and
a moment that is a first time interval from a moment at which the indication information is received, wherein
the available effective moment is a moment with a fixed position in each available effective time window; or
wherein before the receiving, by a terminal, indication information sent by a network side device, the method further comprises:
receiving, by the terminal, monitoring configuration information sent by the network side device; and
the receiving, by a terminal, indication information sent by a network side device comprises:
receiving, by the terminal, the indication information based on the monitoring configuration information.

10. A channel state information reporting and processing method, comprising:
sending, by a network side device, indication information to a terminal, wherein the indication information indicates a change related to channel state information (CSI) reporting configuration.

11. The method according to claim 10, wherein the indication information comprises at least one of the following:
a serving cell identity;
a band width part (BWP) identity;
first indication information, wherein the first indication information indicates to activate or deactivate a first object;
CSI-RS related information;
power offset related information;
second indication information, wherein the second indication information is in a mapping relationship with the first object;
random access channel (RACH) related information;
an antenna port muting pattern identity;
port related information; and
third indication information, wherein the third indication information indicates at least one CSI reporting configuration, wherein
the first object comprises at least one of the following:
a serving cell; a BWP; a CSI reporting configuration; a CSI-RS resource set; a CSI-RS resource configuration; a CSI-RS resource; and a CSI-RS resource group.

12. The method according to claim 11, wherein the CSI-RS related information comprises at least one of the following:
fourth indication information, wherein the fourth indication information indicates at least one CSI-RS resource set;
fifth indication information, wherein the fifth indication information indicates at least one CSI-RS resource configuration;
sixth indication information, wherein the sixth indication information indicates at least one CSI-RS resource; and
seventh indication information, wherein the seventh indication information indicates at least one CSI-RS resource group, and the CSI-RS resource group is a subset of a CSI-RS resource set, or the CSI-RS resource group comprises a plurality of CSI-RS resource sets.

13. The method according to claim 11, wherein the third indication information comprises at least one of the following:
a CSI reporting configuration identity;
CSI reporting configuration list information;
entry information in a CSI reporting configuration list; and
a first bitmap, wherein the first bitmap comprises bits corresponding to different CSI reporting configurations.

14. The method according to claim 12, wherein the seventh indication information comprises at least one of the following:
a CSI-RS resource group identity;
a CSI-RS resource group list;
an entry in a CSI-RS resource group list; and
a fifth bitmap, wherein the fifth bitmap comprises bits corresponding to different CSI-RS resource groups.

15. The method according to claim 14, wherein a grouping rule of the CSI-RS resource group is configured by the network side device; or is related to a number or density of ports of a CSI-RS resource comprised in the CSI-RS resource group.

16. The method according to claim 11, wherein the power offset related information comprises: at least one power offset value; or an identity corresponding to at least one power offset value, wherein
the power offset value is a power offset value between a physical downlink shared channel (PDSCH) and a CSI-RS.

17. The method according to claim 11, wherein the port related information comprises at least one of the following: a port configuration identity, a number of ports, and a port switch pattern.

18. A terminal, comprising at least one hardware processor and a memory having program instructions stored thereon that, when executed by the at least one hardware processor, direct the terminal to:
receive indication information sent by a network side device, wherein the indication information indicates a change related to channel state information (CSI) reporting configuration; and
perform CSI reporting based on the indication information.

19. A network side device, comprising at least one hardware processor and a memory, wherein the memory stores program instructions that, when executed by the at least one hardware processor, direct the at least one hardware processor to implement the method according to claim 10.

20. A non-transitory computer-readable storage medium having program instructions stored thereon that are executable by at least one hardware processor that, when executed, direct the at least one hardware processor to implement the method according to claim 1.
